(19) United States
(12) Patent Application Publication
(10) Pub. No.: US 2023/0351215 A1
(43) Pub. Date: Nov. 2, 2023

(54) DYNAMIC GRAPH NODE EMBEDDING VIA LIGHT CONVOLUTION

(71) Applicant: VISA INTERNATIONAL SERVICE ASSOCIATION, SAN FRANCISCO, CA (US)

(72) Inventors: Jiarui Sun, San Francisco, CA (US); Mengting Gu, Stanford, CA (US); Junpeng Wang, Santa Clara, CA (US); Yanhong Wu, Mountain View, CA (US); Liang Wang, San Jose, CA (US); Wei Zhang, Fremont, CA (US)

(73) Assignee: VISA INTERNATIONAL SERVICE ASSOCIATION, SAN FRANCISCO, CA (US)

(21) Appl. No.: 18/044,736

(22) PCT Filed: Sep. 17, 2021
(86) PCT No.: PCT/US2021/050958

§ 371 Date: Mar. 9, 2023

Related U.S. Application Data
(60) Provisional application No. 63/080,559, filed on Sep. 18, 2020.

(51) Int. Cl. G06N 5/022

(52) U.S. Cl. CPC G06N 5/022

(57) ABSTRACT

A method includes extracting, by an analysis computer, a plurality of first datasets from a plurality of graph snapshots using a graph structural learning module. The analysis computer can then extract a plurality of second datasets from the plurality of first datasets using a temporal convolution module across the plurality of graph snapshots. The analysis computer can then perform graph context prediction with the plurality of second datasets

### CROSS-REFERENCE TO RELATED APPLICATIONS

This application is a PCT application which claims priority to U.S. Provisional Application No. 63/080,559, filed on Sep. 18, 2020, which is herein incorporated by reference.

### BACKGROUND

Learning latent representations (e.g., embeddings) of nodes in graphs is an important and ubiquitous task with widespread applications such as link prediction, node classification, and visualization. However, a vast majority of real-world graphs are dynamic and evolve over time, such as email communication, collaboration, and interaction graphs. Despite the recent success of neural graph representation learning, almost all existing methods focus on static graphs while ignoring the temporal dynamics.

In some cases, when the temporal dynamics of a graph are taken into account, an embedding at a first time-step can be determined, and then an embedding at a second time-step can be determined based on the first embedding of the first time-step. For example, a temporal regularizer is used to enforce smoothness of the embeddings from adjacent time-steps.

However, by doing so, an embedding needs to be determined for every single time-step sequentially, since the embeddings are dependent upon one another. Additionally, any errors, biases, etc. will be propagated through each subsequent embedding due to this dependency on previous embeddings.

Embodiments of the invention address these and other problems individually and collectively.

### BRIEF SUMMARY

One embodiment is related to a method comprising: extracting, by an analysis computer, a plurality of first datasets from a plurality of graph snapshots using a graph structural learning module; extracting, by the analysis computer, a plurality of second datasets from the plurality of first datasets using a temporal convolution module across the plurality of first datasets; and performing, by the analysis computer, graph context prediction with the plurality of second datasets.

Another embodiment is related to an analysis computer comprising: a processor; and a computer readable medium coupled to the processor, the computer readable medium comprising code, executable by the processor, for implementing a method comprising: extracting a plurality of first datasets from a plurality of graph snapshots using a graph structural learning module; extracting a plurality of second datasets from the plurality of first datasets using a temporal convolution module across the plurality of first datasets; and performing graph context prediction with the plurality of second datasets.

Further details regarding embodiments of the invention can be found in the Detailed Description and the Figures.

### BRIEF DESCRIPTION OF THE DRAWINGS

FIG. 1 shows block diagram of a dynamic graph representation learning system according to some embodiments.

FIG. 2 shows a block diagram of an analysis computer according to some embodiments.

FIG. 3 shows a graph of an example of graph embedding according to some embodiments.

FIG. 4 shows a flow diagram illustrating a method of structural self-attention according to some embodiments.

FIG. 5 shows a flow diagram illustrating a method of depthwise temporal convolution, according to some embodiments.

FIG. 6 shows a flow diagram illustrating a method of lightweight temporal convolution, according to some embodiments.

FIG. 7 shows a flow diagram illustrating a method of temporal sequence learning with additional module processes, according to some embodiments.

FIG. 8 shows a flow diagram illustrating a DyCLN architecture according to some embodiments.

FIG. 9 shows a flow diagram illustrating a dynamic graph representation learning process according to some embodiments.

FIG. 10 shows a performance comparison against a first benchmark dataset according to some embodiments.

FIG. 11 shows a performance comparison against a second benchmark dataset according to some embodiments.

### DETAILED DESCRIPTION

Prior to describing embodiments of the disclosure, some terms may be described in detail.

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on a “feature vector” or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, which are collections of artificial “neurons” that perform functions by activating in response to inputs. In some embodiments, a neural network can include a convolutional neural network, a recurrent neural network, etc.

A “model database” may include a database that can store machine learning models. Machine learning models can be stored in a model database in a variety of forms, such as collections of parameters or other values defining the machine learning model. Models in a model database may be stored in association with keywords that communicate some aspect of the model. For example, a model used to evaluate news articles may be stored in a model database in association with the keywords “news,” “propaganda,” and “information.” An analysis computer can access a model database and retrieve models from the model database, modify models in the model database, delete models from the model database, or add new models to the model database.

A “feature vector” may include a set of measurable properties (or “features”) that represent some object or entity. A feature vector can include collections of data represented digitally in an array or vector structure. A feature vector can also include collections of data that can be represented as a mathematical vector, on which vector operations such as the scalar product can be performed. A feature vector can be determined or generated from input data. A feature vector can be used as the input to a machine learning model, such that the machine learning model produces some output or classification. The construction of a feature vector can be accomplished in a variety of ways, based on the nature of the input data. For example, for a machine learning classifier that classifies words as correctly spelled or incorrectly spelled, a feature vector corresponding to a word such as “LOVE” could be represented as the vector (12, 15, 22, 5), corresponding to the alphabetical index of each letter in the input data word. For a more complex “input,” such as a human entity, an exemplary feature vector could include features such as the human's age, height, weight, a numerical representation of relative happiness, etc. Feature vectors can be represented and stored electronically in a feature store. Further, a feature vector can be normalized, i.e., be made to have unit magnitude. As an example, the feature vector (12, 15, 22, 5) corresponding to “LOVE” could be normalized to approximately (0.40, 0.51, 0.74, 0.17).

An “interaction” may include a reciprocal action or influence. An interaction can include a communication, contact, or exchange between parties, devices, and/or entities. Example interactions include a transaction between two parties and a data exchange between two devices. In some embodiments, an interaction can include a user requesting access to secure data, a secure webpage, a secure location, and the like. In other embodiments, an interaction can include a payment transaction in which two devices can interact to facilitate a payment.

A “topological graph” can include a representation of a graph in a plane of distinct vertices connected by edges. The distinct vertices in a topological graph may be referred to as “nodes.” Each node may represent specific information for an event or may represent specific information for a profile of an entity or object. The nodes may be related to one another by a set of edges, E. An “edge” may be described as an unordered pair composed of two nodes as a subset of the graph G=(V, E), where is G is a graph comprising a set V of vertices (nodes) connected by a set of edges E. For example, a topological graph may represent a transaction network in which a node representing a transaction may be connected by edges to one or more nodes that are related to the transaction, such as nodes representing information of a device, a user, a transaction type, etc. An edge may be associated with a numerical value, referred to as a “weight,” that may be assigned to the pairwise connection between the two nodes. The edge weight may be identified as a strength of connectivity between two nodes and/or may be related to a cost or distance, as it often represents a quantity that is required to move from one node to the next. In some embodiments, a graph can be a dynamic graph, which may change over time. For example, nodes and/or edges may be added to and/or removed from the graph.

A “subgraph” or “sub-graph” can include a graph formed from a subset of elements of a larger graph. The elements may include vertices and connecting edges, and the subset may be a set of nodes and edges selected amongst the entire set of nodes and edges for the larger graph. For example, a plurality of subgraph can be formed by randomly sampling graph data, wherein each of the random samples can be a subgraph. Each subgraph can overlap another subgraph formed from the same larger graph.

A “community” can include a group of nodes in a graph that are densely connected within the group. A community may be a subgraph or a portion/derivative thereof and a subgraph may or may not be a community and/or comprise one or more communities. A community may be identified from a graph using a graph learning algorithm, such as a graph learning algorithm for mapping protein complexes. Communities identified using historical data can be used to classify new data for making predictions. For example, identifying communities can be used as part of a machine learning process, in which predictions about information elements can be made based on their relation to one another.

The term “node” can include a discrete data point representing specified information. Nodes may be connected to one another in a topological graph by edges, which may be assigned a value known as an edge weight in order to describe the connection strength between the two nodes. For example, a first node may be a data point representing a first device in a network, and the first node may be connected in a graph to a second node representing a second device in the network. The connection strength may be defined by an edge weight corresponding to how quickly and easily information may be transmitted between the two nodes. An edge weight may also be used to express a cost or a distance required to move from one state or node to the next. For example, a first node may be a data point representing a first position of a machine, and the first node may be connected in a graph to a second node for a second position of the machine. The edge weight may be the energy required to move from the first position to the second position.

“Graph data” can include data represented as a topological graph. For example, graph data can include data represented by a plurality of nodes and edges. Graph data can include any suitable data (e.g., interaction data, communication data, review data, network data, etc.).

A “graph snapshot” can include graph data within a time range. For example a graph snapshot may include graph data occurring during a 3 day, 1 week, 2 month, etc. period of time.

A “graph context prediction” can include any suitable prediction based on graph data. In some embodiments, the prediction can relate to the context of at least some part of the graph or the graph data. For example, if the graph data was formed from weather data, then the prediction may relate to predicting the weather in a particular location. In some embodiments, a graph context prediction may be made by a machine learning model that is formed using final node representations (also referred to as final vector representations of nodes), which may correspond to data from second data sets. In some embodiments, the graph context prediction may be a classification by a machine learning model of some input data.

“Vector representations” can include vectors which represent something. In some embodiments, vector representations can include vectors which represent nodes from graph data in a vector space. In some embodiments, vector representations can include embeddings.

A “dataset” can include a collection of related sets of information that can be composed of separate elements but can be manipulated as a unit by a computer. In some embodiments, a dataset can include a plurality of vectors. For example, in some embodiments, a first dataset can include a plurality of intermediate vector representations, and a second dataset can include a plurality of final node representations.

A “kernel” can include a set of values. A kernel can have any suitable length, such as a length of two values, three values, four values, five values, or any other suitable number of values. In some embodiments, a kernel can include a series of weight parameter values, which can be normalized. Weight parameter values may be trained using historical data and machine learning processes. In some embodiments, a kernel is unique to a certain feature dimension of a vector. In other embodiments, a kernel can be used for multiple feature dimensions of a vector.

A “server computer” may include a powerful computer or cluster of computers. For example, the server computer can be a large mainframe, a minicomputer cluster, or a group of servers functioning as a unit. In one example, the server computer may be a database server coupled to a web server. The server computer may comprise one or more computational apparatuses and may use any of a variety of computing structures, arrangements, and compilations for servicing the requests from one or more client computers.

A “memory” may include any suitable device or devices that may store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “processor” can include to any suitable data computation device or devices. A processor may comprise one or more microprocessors working together to accomplish a desired function. The processor may include a CPU that comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

### I. INTRODUCTION

Embodiments of the disclosure, in some cases also referred to as Dynamic Graph Light Convolution Network (DGLC), can operate on dynamic graphs and learn node representations that capture both structural features and temporal evolution patterns. Embodiments may allow an analysis computer to compute node representations by first employing a graph structural learning layer to effectively capture structural neighborhood information, and then employing a temporal convolution layer to efficiently capture the temporal evolution of graph sequences. In contrast to existing techniques, temporal convolution of embodiments can enable learning adaptive temporal evolution patterns at a fine-grained node-level granularity. Further temporal convolution can achieve processing efficiency through utilizing a attending over a single dimension of input features within a temporal kernel window, and avoiding unnecessary computational cost.

Learning latent representations (or embeddings) of nodes in graphs has been recognized as a fundamental learning problem due to widespread use in various domains such as biology (Grover & Leskovec, 2016), social media (Perozzi et al., 2014), and knowledge bases (Wang et al., 2014). The idea is to encode structural properties (and possibly attributes) of a node's neighborhood into a low-dimensional vector. Such low-dimensional representations can benefit a plethora of graph analytical tasks such as node classification, link prediction, and graph visualization (Perozzi et al., 2014; Grover & Leskovec, 2016; Wang et al., 2016; Tang et al., 2015).

Previous work on graph representation learning mainly focuses on static graphs, which contain a fixed set of nodes and edges. However, many graphs in real-world applications are intrinsically dynamic, in which graph structures can evolve over time. A dynamic graph may be represented as a sequence of graph snapshots from different time steps (Leskovec et al., 2007). Examples include academic co-authorship networks in which authors may periodically switch their collaboration behaviors and email communication networks whose structures may change dramatically due to sudden events. In such scenarios, modeling temporal evolutionary patterns can be important in accurately predicting node properties and future links.

Learning dynamic node representations is challenging, compared to static settings, due to the complex time-varying graph structures. For example, nodes can emerge and leave, links (e.g., edges) can appear and disappear, and communities can merge and split. This may require the learned embeddings not only to preserve structural proximity of nodes, but also to jointly capture the temporal dependencies over time. Although some recent work attempts to learn node representations in dynamic networks, they mainly impose a temporal regularizer to enforce smoothness of the node representations from adjacent snapshots, see (Zhu et al., 2016; Li et al., 2017; Zhou et al., 2018). However, these approaches fail when nodes exhibit significantly distinct evolutionary behaviors. Trivedi et al., (2017) employ a recurrent neural architecture for temporal reasoning in multi-relational knowledge graphs. However, this approach learns temporal node representations by focusing only on link-level evolution, while ignoring the structure of local graph neighborhoods.

Attention mechanisms have recently achieved great success in many sequential learning tasks such as machine translation (Bandanau et al., 2015) and reading comprehension (Yu et al., 2018). An underlying principle of attention mechanisms can be to learn a function that aggregates a variable-sized input, while focusing on the parts most relevant to a certain context. When the attention mechanism uses a single sequence as both the inputs and the context, it is often named as self-attention. Though attention mechanisms were initially designed to facilitate Recurrent Neural Networks (RNNs) to capture long-term dependencies, recent work by (Vaswani et al., (2017)) demonstrate that a fully self-attentional network itself can achieve state-of-the-art performance in machine translation tasks. (Velickovic et al., (2018)) extend self-attention on graphs by enabling each node to attend over its neighbors, achieving state-of-the-art results for semi-supervised node classification tasks in static graphs.

Some work has recently been proposed to learn node representations on dynamic graphs. To capture the evolutionary patterns, these methods mainly utilize two categories of techniques: Recurrent Neural Network (RNN) [Goyal et al., 2020; Pareja et al., 2020] and the attention mechanism [Sankar et al., 2020; Xu et al., 2020]. RNN-based models take either a graph snapshot or a set of Graph Neural Network (GNN) weights as input at each time step so that their hidden states are optimized to summarize and learn historical graph changes. Attention-based methods, on the other hand, model the temporal information by weighting and aggregating the structural information of each graph snapshot at different time steps. However, the training processes of these two types of models can be time consuming, especially when modeling graphs with long time sequences. Specifically, RNN-based models need to sequentially process each of the graph snapshots, while attention-based models compute the weight coefficient of an entire graph sequence. In addition, both types of models pose significant challenges to hardware memory requirements. These challenges prevent the application of existing dynamic graph representation learning methods in domains where there are large dynamic graphs with many time steps.

In contrast, embodiments of the disclosure provide a novel neural architecture to efficiently learn node representations on dynamic graphs. Specifically, embodiments can employ self-attention for structural neighborhoods and temporal dynamics. Embodiments can employ a graph structural learning layer to effectively capture structural neighborhood information, and then employ a temporal convolution layer to efficiently capture the temporal evolution of graph sequences. For example, embodiments can allow for an analysis computer to generate a node representation by considering the node's neighbors following a self-attentional strategy and then node's historical representations following a temporal convolution strategy. Unlike static graph embedding methods that focus entirely on preserving structural proximity, embodiments can learn dynamic node representations that reflect the temporal evolution of graph structure over the varying number of historical snapshots. Embodiments can be capable of accurately capturing both structural properties and temporal evolution patterns. In contrast to temporal smoothness-based methods, embodiments can learn attention weights that capture temporal dependencies at a fine-grained node-level granularity.

Compared with past approaches, embodiments can achieve a better processing efficiency when capturing the temporal evolution of graph sequences. First, each lightweight convolution kernel may only attend over a single dimension of input features within a temporal kernel window. This may be acceptable due to the fact that the cross-dimension feature interactions have already been captured from the structural layer. As a result, embodiments avoid unnecessary computation and thereby improve model optimization. In addition, embodiments can share weights (e.g., kernels) across certain feature dimensions, and can thereby reduce the number of parameters. This both regularizes the model and reduces computational cost. These advantages make embodiments of the invention powerful and efficient, especially when modeling dynamic graphs with long time sequences.

A. System Overview

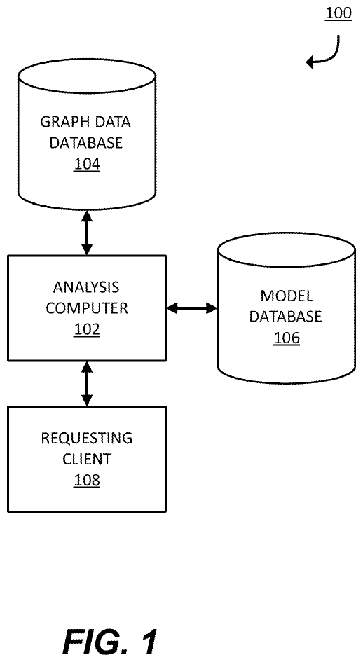

FIG. 1 shows a block diagram of a system 100 comprising a number of components according to some embodiments. The system 100 comprises an analysis computer 102, a graph data database 104, a model database 106, and a requesting client 108. The analysis computer 102 can be in operative communication with the graph data database 104, the model database 106, and the requesting client 108 (e.g., a remote computer).

For simplicity of illustration, a certain number of components are shown in FIG. 1. It is understood, however, that embodiments of the disclosure may include more than one of each component. In addition, some embodiments of the disclosure may include fewer than or greater than all of the components shown in FIG. 1.

Messages between the devices of system 100 in FIG. 1 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The graph data database 104 may securely store graph data. The graph data database 104 can store graph data (e.g., topological graph data). In some embodiments, the graph data database 104 may store a plurality of graph snapshots of a dynamic graph.

The model database 106 can securely store models. For example, the analysis computer 102 can create a model (e.g., a machine learning model) and can store the model in the model database 106. In some embodiments, the graph data database 104 and the model database 106 may be conventional, fault tolerant, relational, scalable, secure databases such as those commercially available from Oracle™, Sybase™, etc.

The analysis computer 102 can be capable of performing dynamic graph representation learning via self-attention networks and lightweight convolution as described herein. The analysis computer 102 can be capable of retrieving graph data from the graph data database 104. In some embodiments, the analysis computer 102 can be capable of retrieving graph snapshots from the graph data database 104.

The analysis computer 102 can be capable of extracting a plurality of first datasets from a plurality of graph snapshots using a graph structural learning module. The analysis computer 102 can then be capable of extracting at least a second dataset from the plurality of first datasets using a temporal convolution module across the plurality of graph snapshots. Extraction of the plurality of first datasets can the second dataset are described in further detail herein. The analysis computer 102 can also be capable of performing graph context prediction with at least the second dataset.

The requesting client 108 can include any suitable device external to the analysis computer 102. In some embodiments, the requesting client 108 may receive outputs and/or decisions made by the analysis computer 102. In other embodiments, the requesting client 108 can transmit a request (e.g., a prediction request) to the analysis computer 102. The request can include request data regarding a model. The requesting client 108 can request the analysis computer 102 to run a model to, for example, predict whether or not two nodes of the graph data will be connected via an edge in a future graph snapshot. After receiving the request comprising request data, the analysis computer 102 can determine output data. For example, the analysis computer 102 can input the request data into the model to determine output data, output by the model. The analysis computer 102 may then provide the output data to the requesting client 108.

For example, in some embodiments, the analysis computer 102 can receive a prediction request from the requesting client 108. The prediction request can comprise, for example, a request for a prediction of whether or not a first author represented by a first node in collaboration graph data will be connected to (e.g., perform research with) a second author represented by a second node at a future point in time.

The analysis computer 102 can then determine a prediction based on at least performing graph context prediction with at least the second dataset. For example, the analysis computer 102 can predict whether or not the first author and the second author will collaborate on a research paper at a given time-step in the future using a model created as described herein. For example, the analysis computer 102 may determine that the two authors are predicted as being 90% likely to collaborate on a research paper within the next year.

After determining the prediction, the analysis computer 102 can perform any suitable action based on the prediction. For example, an action can include transmitting a prediction response message comprising at least the prediction to the requesting client 108. For example, the analysis computer 102 can send a message providing prediction that the two authors are likely to collaborate within the next year. In another example, the analysis computer can send an advisory notice that a transaction is likely to take place, or that a current transaction being attempted was not likely to take place and may therefore be fraudulent.

B. Analysis Computer

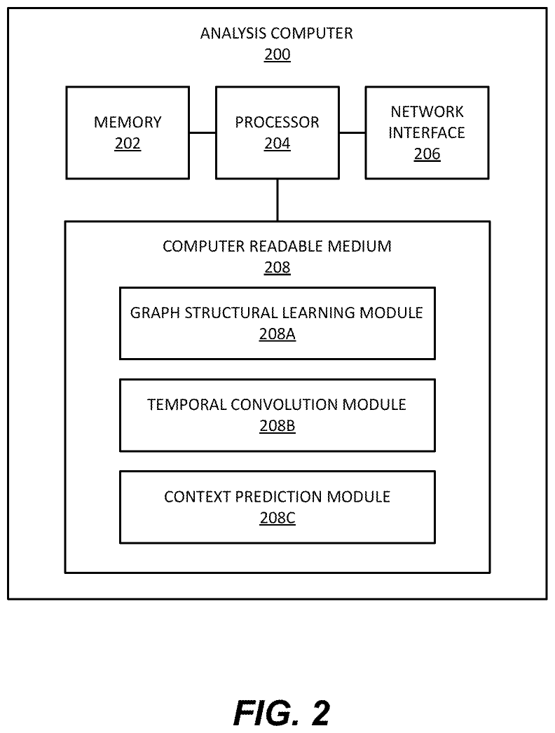

FIG. 2 shows a block diagram of an analysis computer 200 according to embodiments. The exemplary analysis computer 200 may comprise a processor 204. The processor 204 may be coupled to a memory 202, a network interface 206, input elements 210, output elements 212, and a computer readable medium 208. The computer readable medium 208 can comprise a graph structural learning module 208A, a temporal convolution module 208B, and a context prediction module 208C.

The memory 202 can be used to store data and code. The memory 202 may be coupled to the processor 204 internally or externally (e.g., cloud based data storage), and may comprise any combination of volatile and/or non-volatile memory, such as RAM, DRAM, ROM, flash, or any other suitable memory device. For example, the memory 202 can store graph data, vectors, datasets, etc.

The computer readable medium 208 may comprise code, executable by the processor 204, for performing a method comprising: extracting, by an analysis computer, a plurality of first datasets from a plurality of graph snapshots using a graph structural learning module; extracting, by the analysis computer, at least a second dataset from the plurality of first datasets using a temporal convolution module across the plurality of graph snapshots; and performing, by the analysis computer, graph context prediction with at least the second dataset.

The graph structural learning module 208A may comprise code or software, executable by the processor 204, for performing graph structural learning, such as structural self-attention. The graph structural learning module 208A, in conjunction with the processor 204, can attend over immediate neighboring nodes of a particular node (e.g., node v). For example, the graph structural learning module 208A, in conjunction with the processor 204, can attend over the immediate neighboring nodes by determining attention weights (e.g., in an attentional neural network) as a function of the input nodes. In some embodiments, the graph structural learning module 208A, in conjunction with the processor 204, can determine intermediate vector representations for each node for each snapshot of the plurality of graph snapshots using equation (1), described in further detail below. The graph structural learning module 208A, in conjunction with the processor 204, can determine intermediate vector representations for each graph snapshot independently of other graph snapshots.

For example, the graph structural learning module 208A, in conjunction with the processor 204, can receive a first graph snapshot of graph data (e.g., a dynamic graph). The graph data may be communication data which includes particular users (e.g., represented as nodes) and communications between the users (e.g., represented as edges). The graph structural learning module 208A, in conjunction with the processor 204, can first determine what nodes are connected to a first node (e.g., a first user in the communication network). The nodes connected (via edges) to the first user can be neighboring nodes. The neighboring nodes of the first node can be used when determining the embedding of the first node. In such a way, attention may be placed on the first node's neighboring nodes when determining the vector representation of the first node, thus capturing structural patterns in the graph data.

The temporal convolution module 208B may comprise code or software, executable by the processor 204, for performing temporal convolution. The temporal convolution module 208B, in conjunction with the processor 204, can capture temporal evolutionary patterns in the graph data over a plurality of graph snapshots. The input to the temporal convolution module 208B can include the intermediate vector representations determined by the structural convolution module 208A, in conjunction with the processor 204. For example, the temporal convolution module 208B, in conjunction with the processor 204, can accept, as input, at least the vector representation of the first node from each graph snapshot. The vector representation of the first node can constitute an encoding of a local structure around the first node. In some embodiments, the temporal convolution module 208B, in conjunction with the processor 204, can extract at least a second dataset from the plurality of first datasets across the plurality of graph snapshots using equation (2), as described in further detail below.

For example, the graph structural learning module 208A, in conjunction with the processor 204, can determine an intermediate vector representation of the first node. A plurality of intermediate vector representations can include the intermediate vector representation of the first node at each graph snapshot. The temporal convolution module 208B, in conjunction with the processor 204, can then receive the plurality of intermediate vector representations of the first node. The temporal convolution module 208B, in conjunction with the processor 204, can utilize the plurality of intermediate vector representations to convolute (e.g., using lightweight convolution) over the first node's historical representations, imprinting information from intermediate vector representations of first node onto one another (e.g., within a certain time window). As a result, the temporal convolution module 208B, in conjunction with the processor 204, can determine one or more final node representations for the first node for the graph data. The final node representations can be vectors which represent the change in the intermediate vector representations over time (e.g., within a certain time window). Thus, the final node representations can encode data regarding the structure of the graph as well as the change of the structure over time.

For example, the final node representations of the first node may represent the first user's communication habits and how they evolve over time. The first node may communicate with a particular group of nodes through a portion of time, then drift to communicating with a different group of nodes. The final node representations of the first node can be formed such that they indicate or reflect the first user's change in communication.

In some embodiments, the analysis computer can create any suitable type of model using at least the second dataset, for example, the model can include a machine learning model (e.g., support vector machines (SVMs), artificial neural networks, decision trees, Bayesian networks, genetic algorithms, etc.). In some embodiments, the model can include a mathematical description of a system or process to assist calculations and predictions (e.g., a fraud model, an anomaly detection model, etc.).

For example, analysis computer 200 can create a model, which may be a statistical model, which can be used to predict unknown information from known information. For example, the analysis computer 200 can include a set of instructions for generating a regression line from training data (supervised learning) or a set of instructions for grouping data into clusters of different classifications of data based on similarity, connectivity, and/or distance between data points (unsupervised learning). The regression line or data clusters can then be used as a model for predicting unknown information from known information.

Once the model has been built from at least the second dataset by the analysis computer, the model may be used to generate a predicted output from a request by the context prediction module 208C, in conjunction with the processor 204. The context prediction module 208C can include may comprise code or software, executable by the processor 204, for performing context prediction. For example, the received request may be a request for a prediction associated with presented data. For example, the request may be a request for classifying a transaction as fraudulent or not fraudulent, or for a recommendation for a user.

The graph context prediction module 208C, in conjunction with the processor 204, can perform any suitable prediction based on the context of the graph data. For example, the analysis computer 200 can determine a prediction relating to graph data. In some embodiments, the prediction can relate to the context of the graph to which the graph data is associated. The analysis computer 200 can, for example, perform graph context prediction to determine a prediction of whether or not a resource provider and a user will transact at some point in the next week. As an illustrative example, the second dataset, determined by the temporal convolution module 208B, in conjunction with the processor 204, can be used as input for machine learning models, such as a regression model or a classification model, to make a prediction such as whether two nodes will be linked or a class a node will belong to. In some embodiments, the second dataset can be used to train a neural network. For example, the second dataset may correspond to graph data comprising resource providers and users connected via interactions. The neural network can be trained in any suitable manner with the second dataset which includes vectors. In some embodiments, the neural network can be trained to classify input vectors as either, for example, fraud or not fraud. As another example, the neural network can be trained to predict whether or not two nodes will be connected via an edge (e.g., a particular resource provider and user transact) in a future graph snapshot, a time associated with such a snapshot, and/or whether the edge will represent an approved or declined transaction.

The network interface 206 may include an interface that can allow the analysis computer 200 to communicate with external computers. The network interface 206 may enable the analysis computer 200 to communicate data to and from another device (e.g., a requesting client, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

### II. RELATED WORK

Embodiments may be related to representation learning techniques on static graphs, dynamic graphs, self-attention mechanisms, etc.

Early work on unsupervised graph representation learning exploits the spectral properties of various matrix representations of a graph (e.g., Laplacian, etc.) to perform dimensionality reduction (Belkin & Niyogi, 2001; Tenenbaum et al., 2000). To improve scalability to large graphs, more recent work on graph embeddings has established the effectiveness of random walk based methods, inspired by the success of natural language processing. For example, Deepwalk (Perozzi et al., 2014) learns node embeddings by maximizing the co-occurrence probability of nodes appearing within a window, in a random walk. Node2vec (Grover & Leskovec, 2016) extends the model with flexibility between homophily and structural equivalence. In recent years, several graph neural network architectures based on generalizations of convolutions, have achieved tremendous success, with a vast majority of them designed for supervised or semi-supervised learning (Niepert et al., 2016; Defferrard et al., 2016; Kipf & Welling, 2017; Sankar et al., 2017; Velickovic et al., 2018). Further, Hamilton et al., (2017) extend graph convolutional approaches through trainable neighborhood aggregation functions, to propose a general framework applicable to unsupervised representation learning. However, these methods are not designed to model temporal evolutionary behavior in dynamic graphs.

Most techniques employ temporal smoothness regularization to ensure embedding stability across consecutive time-steps (Zhu et al., 2016; Li et al., 2017). Zhou et al., (2018) additionally use triadic closure (Kossinets & Watts, 2006) as guidance, leading to significant improvements. Neural methods were recently explored in the knowledge graph domain by Trivedi et al., (2017), who employ a recurrent neural architecture for temporal reasoning. However, their model is limited to tracing link evolution, but ignores the local neighborhood while computing node representations. Goyal et al., (2017) learn incremental node embeddings through initialization from the previous time step, which however may not suffice to model historical temporal variations. Unlike previous approaches, embodiments can learn adaptive temporal evolution patterns at a node-level granularity through a self-attentional architecture.

Dynamic graphs can be generally categorized by its representation into discrete graphs and continuous graphs. Discrete graphs use an ordered sequence of graph snapshots, where each snapshot represents aggregated dynamic information within a fixed time interval. On the other hand, continuous graphs maintain detailed temporal information and are often complex to model comparing to discrete graphs. In this work, the focus is on the discrete graph setting and learning node representations from graph snapshot sequences.

For discrete dynamic graph learning, many existing utilizes recurrent models to capture the temporal dynamics into hidden states. Some work uses separate GNNs to model individual graph snapshot, and uses RNN to learn temporal dynamics [Seo et al., 2018; Manessi et al., 2020]; some other work integrates GNN and RNN together into one layer, aiming to learn the spatial and temporal information concurrently [Pareja et al., 2020; Chen et al., 2018]. However, recurrent structures introduce sequential dependence during training, which has scalability issues when modeling long input sequences. Sankar et al. [Sankar et al., 2020] use the self-attention mechanism along both the spatial and temporal dimensions of dynamic graphs, showing better performance comparing to GNN with RNN methods. However, both RNN units and attention mechanisms can become inefficient when modeling dynamic graphs with long input sequences.

Existing work on continuous dynamic graphs include RNN-based methods and temporal random walk based methods, and temporal point process based methods. RNN-based methods perform representation updates through recurrent models at fine-grained timestamps [Kumar et al., 2019], and the other two categories incorporate temporal dependencies through temporal random walks and parameterized temporal point process [Nguyen et al., 2018; Trivedi et al., 2019]. However, these methods are not applicable for dynamic graphs without detailed event timestamps.

Recent advancements in many Natural Language Processing (NLP) tasks have demonstrated the superiority of self-attention in achieving state-of-the-art performance (Vaswani et al., 2017; Lin et al., 2017; Tan et al., 2018; Shen et al., 2018; Shaw et al., 2018). In embodiments of the disclosure, self-attention can be employed to compute a dynamic node representation by attending over its neighbors and previous historical representations. An approach of some embodiments may include using self-attention over neighbors and may be related to the Graph Attention Network (GAT) (Velickovic et al., 2018), which employs neighborhood attention for semi-supervised node classification in a static graph.

### III. DYNAMIC GRAPH LIGHT CONVOLUTION NETWORK ARCHITECTURE

In some embodiments, an analysis computer can be configured to determine embeddings of graph data. For example, the analysis computer can determine final node representations, which may be final embeddings. The graph representations may then be used in graph context prediction. To determine a graph representation, the analysis computer can retrieve graph data from a graph data database. In some embodiments, after retrieving the graph data, the analysis computer can determine a plurality of graph snapshots from the graph data. In other embodiments, the graph data may be stored as a plurality of graph snapshots in the graph data database, in which case, the analysis computer can retrieve the plurality of graph snapshots in the graph data database.

The analysis computer can then extract a plurality of first datasets from the plurality of graph snapshots using a graph structural learning module. The plurality of first datasets can include, for example, intermediate vector representations for each node for each snapshot of the plurality of graph snapshots. The intermediate vector representations can be vectors representative of the nodes of the graph snapshots. For example, the intermediate vector representations can be in a vector space which may represent characteristics of the graph data. For example, if two nodes of a graph snapshot are similar (e.g., share a plurality of attributes), then the vectors representing the two nodes may be similar in the vector space.

As an illustrative example, graph data can include interaction data (e.g., transaction data, etc.). The graph data can be a dynamic graph comprising a plurality of graph snapshots. Each graph snapshot can include any suitable number of nodes and edges. The nodes of the graph data can represent resource providers and users. Edges may connect a resource provider node to a user node when the two have performed a transaction. The analysis computer can determine a first dataset from each graph snapshot. For example, the analysis computer, for each node, can determine a vector (e.g., an intermediate vector representation) based on a node's neighboring nodes (e.g., local structure). The intermediate vector representation can be determined though a self-attentional neural network, where the analysis computer determines how much attention (e.g., weight) to give to a node's neighboring nodes, based on their influence on the node.

For example, during the self-attentional process, the analysis computer can determine an intermediate vector representation for a first user node. The analysis computer can determine values which represent the attention which can be placed on links between the first user node and each resource provider node that the first user node is connected to. For example, the first user node may be connected via edges to three resource provider nodes including a first resource provider located in San Francisco and provides resources of groceries, a second resource provider located in San Francisco and provides resources of electronics, and a third resource provider located in New York and provides resources of digital books. The analysis computer can attend over the nodes to determine the intermediate vector representation of the first user node. For example, the first user node may be associated with a location of San Francisco and is associated as being a part of an electronics community group. The analysis computer can determine values using the self-attentional neural network, where the inputs can include the first user node and the neighboring nodes, as described in further detail herein. The output of the neural network can include a vector including values representing a degree of how closely the first user node relates to each of the input nodes. For example, in some embodiments, the first user node may most closely relate to itself, as it shares all of its own characteristics. The first user node can then relate to the second resource provider (San Francisco, electronics), the first resource provider (San Francisco, groceries), and the third resource provider (New York, digital books), in descending order of degree of likeness, since the first user node is associated with San Francisco and electronics.

The analysis computer can then extract at least a second dataset from the plurality of first datasets using a temporal convolution module across the plurality of graph snapshots. The second dataset can include, for example, a plurality of final node representations (also referred to as final vector representations of nodes) for a graph comprising the plurality of graph snapshots. The plurality of final node representations can be vectors which further represent the changes of the structure of the nodes over time (e.g., for a certain time window as defined by a kernel size). For example, the final node representations can be in a vector space which may represent characteristics of the graph data. For example, if vectors of the intermediate vector representations are similar over time, then they may be represented by final node representations which are close to one another in a final vector space.

For example, if two nodes representing resource providers portray similar characteristics over time (e.g., both resource providers transact with many users in the summer, but then do not perform many transactions in the winter), then final node representations representing these two resource providers may be close to one another (e.g., the vectors have similar magnitudes and directions). For example, the above described first user node may be associated with an intermediate vector representation which describes the local structure around the first user node (e.g., including weights which describe the relation between the first user node and each neighboring node). Between a first graph snapshot and a second graph snapshot, the local structure around the first user node can change. A temporal convolution process can determine how the intermediate vector representations of the first user node change throughout the graph snapshots. In this way, temporal patterns can be determined and encoded into a set of final node representations which can represent the first user node's local structure over time (e.g., a predefined time window).

After extracting the second dataset (e.g., the set of final node representations), the analysis computer can perform graph context prediction with at least the second dataset. As an illustrative example, the second dataset can be used as input for machine learning models, such as a regression model or a classification model, to make a prediction, such as whether two nodes will be linked or a class a node will belong to. In some embodiments, graph context prediction can include determining whether or not a first node will interact with a second node in the future. For example, the analysis computer can train any suitable machine learning model using the final node representations (also referred to as final vector representations of nodes). The analysis computer can train a feed forward neural network, for example, capable to determining whether or not two nodes will be connected via an edge in a future graph snapshot.

Illustratively, the analysis computer can determine whether or not a first node representing a resource provider will transact with a second node representing a user (e.g., a consumer) in the next week, month, two months, etc. The analysis computer can also perform an action, such as sending a message informing the resource provider regarding a predicted transaction.

A. Problem Definition

A discrete-time dynamic graph can include a series of observed snapshots, [symbol] ={ [symbol] , . . . , [symbol] } where T can be a number of time-steps. Each snapshot [symbol] ₜ=( [symbol] ,ε^{t}, [symbol] ^{t}) can be a weighted undirected graph including a shared node set V, a link (e.g., edge) set Et and weights Wt, depicting the graph structure at time t. The corresponding weighted adjacency matrix of the graph snapshot [symbol] ₜ can be denoted by [symbol] . Unlike some previous works that assume dynamic graphs only grow over time, embodiments of the disclosure can allow for both addition and deletion of links (e.g., edges). Embodiments can allow an analysis computer to learn latent representations eᵥ^{t} [symbol] for each node v e V at time-steps t=1, 2, . . . , T, such that the representations eᵥ^{t} both preserves the local structure around a node v and models the local structural evolution over time. The latent representations eᵥ^{t} can be final node representations.

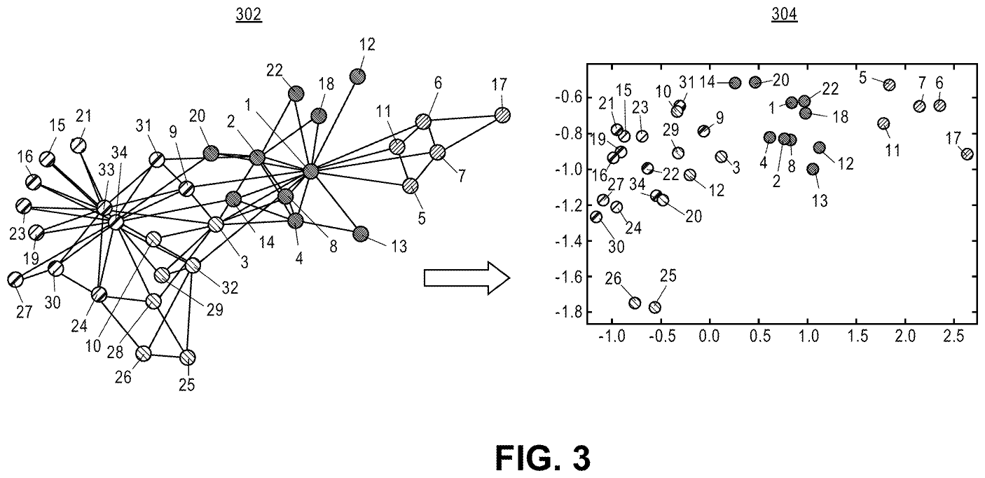

FIG. 3 shows an example of graph embedding according to embodiments. An analysis computer can learn a latent vector space representation for a node, such that, two structurally similar nodes of the graph data can be embedded similarly in the vector space. FIG. 3 includes a snapshot of a graph 302 comprising nodes and edges connecting the nodes. FIG. 3 also includes a vector space 304 representation of the graph 302. Although two dimension are illustrated in the vector space 304, it is understood that the vector space 304 can be multi-dimensional.

In some embodiments, an embedding can be a mapping of a discrete or categorical variable to a vector of continuous numbers. In the context of neural networks, embeddings can be low-dimensional, learned continuous vector representations of discrete variables. Neural network embeddings can be useful because they can reduce the dimensionality of categorical variables and meaningfully represent categories in the transformed space. In some embodiments, a vector which may represent the node can be determined using a neural network.

The analysis computer can determine a vector representation for each node in the graph 302. The vector space 304 can illustrate the location of each vector corresponding to each node in a vector space. For example, the node numbered 13 of the graph 302 can be embedded as a vector of [1.1, −1.0] in the vector space 304.

For example, the graph 302 can be a communication network representing users (e.g., nodes) who communicate with one another (e.g., via edges). the node 8 and the node 2 can represent, for example, users who have similar communication habits. The user represented by node 2 may communicate (e.g., via email, phone, text, etc.) with other users as indicated by edges to other nodes of the graph 302. The user represented by node 8 may communicate with many of the same users as done by node 2. As such, node 2 and node 8 may have similar characteristics.

An analysis computer can determine embeddings for the nodes the graph 302. The analysis computer can determine a vector representation of each node of the graph 302. For example, the analysis computer can determine a vector of [0.75, −0.81] for node 2 and a vector of [0.80, −0.82] for node 8 in the vector space 304. Since the nodes 2 and 8 have similar characteristics, the analysis computer can determine similar vectors for the nodes 2 and 8.

B. Model Overview

In this section, the architecture of embodiments will be described. Embodiments can efficiently generate representative node embeddings to track the temporal evolution of dynamic graphs. A graph structure learning module can capture structural information of each graph snapshot. A temporal sequence learning module can efficiently fuse the structural information learned from historical time steps. The two modules can be utilized in an unsupervised approach.

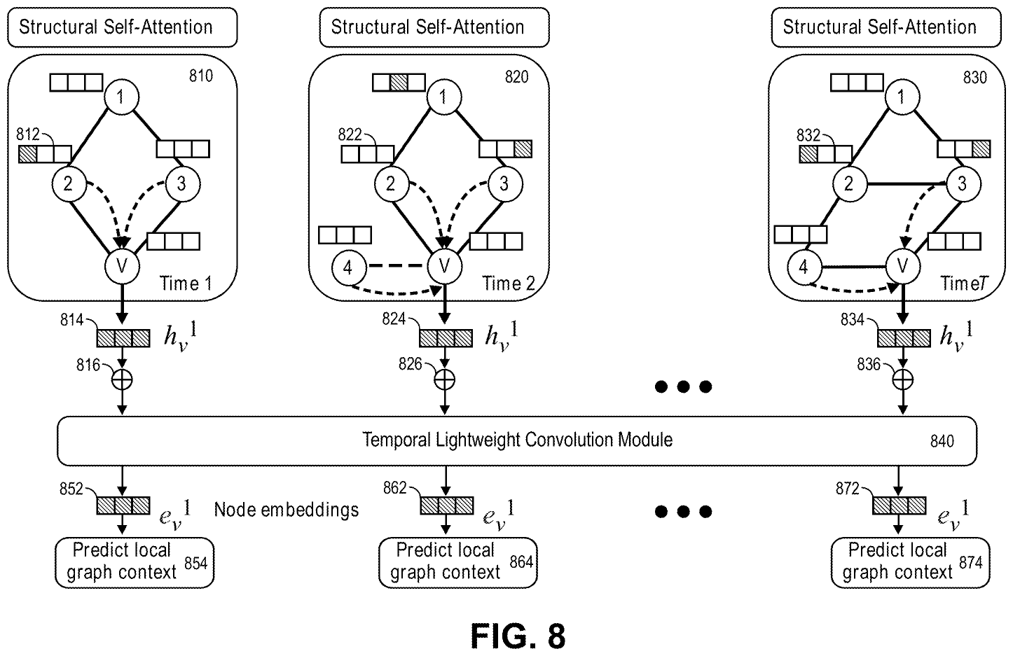

In some embodiments, a graph structural learning block can be followed by a temporal convolution block, as illustrated in FIG. 8 described below, where each block can contain multiple stacked layers of the respective type. The graph structural learning block can use self-attention to extract features from a local neighborhood (e.g., around a node) through self-attentional aggregation to compute intermediate vector representations for each graph snapshot. These representations can feed as input to the temporal convolution block, which can convolute over multiple time steps for each feature of each vector, capturing the temporal variations in the vector. The output of the temporal convolution process can include final node representations (also referred to as final vector representations of nodes) which may be utilized in training a machine learning model and performing graph context prediction.

C. Graph Structure Learning

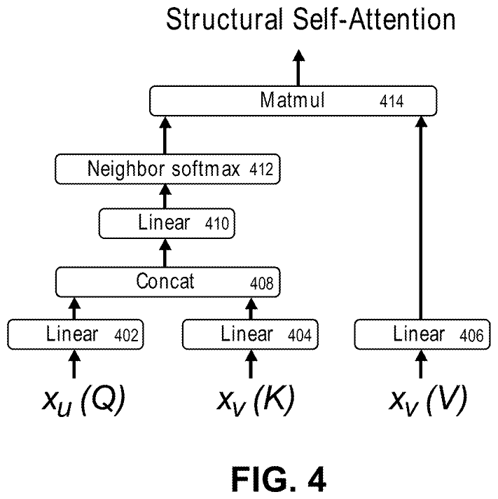

FIG. 4 shows a flow diagram illustrating method of graph structure learning through structural self-attention, according to some embodiments. The structural self-attention method of FIG. 4 can accept three inputs xᵤ(Q), xᵥ(K), and xᵥ(V). An attention function can be described as mapping a query Q and a set of key-value pairs (e.g., K and V, respectively) to an output, where the query, keys, values, and output can all be vectors, or in some embodiments matrices. The output can be computed as a weighted sum of the values, where the weight assigned to each value is computed by a compatibility function of the query with the corresponding key.

The graph structure learning process can learn the structural properties of a graph snapshot [symbol] ∈ [symbol] v by aggregating information from each node's immediate neighborhoods. For example, the input to the graph structural learning layer can be a graph snapshot [symbol] ∈ [symbol] , where [symbol] can be a dynamic graph (e.g., graph data), and a set of input node representations {xᵥ∈ [symbol] ,∀ᵥ∈ [symbol] } where D can be the dimensionality of the input embeddings. The graph structural learning layer can output a new set of node representations {zᵥ∈ [symbol] ,∀ᵥ∈ [symbol] } with dimensionality F. For example, the graph structural learning layer can output intermediate vector representations representing the nodes.

The graph structural learning layer can attend over the immediate neighbors of a node v at time t, by computing attention weights as a function of their input node embeddings. In some embodiments, the structural attention layer can be a weighted variant of GAT (Velickovic et al., 2018), applied on a graph snapshot:

$${z}_{v} = σ ( {\sum }_{u ∈ {𝒩}_{v}} {α}_{u ν} {W}^{s} {x}_{u} ) , \qquad ( 1 )$$

$${α}_{u ν} = \frac{exp ( σ ( {A}_{u v} \cdot {a}^{T} [ {W}^{s} {x}_{u} \vert \vert {W}^{s} {x}_{v} ] ) )}{{\sum }_{ω ∈ {𝒩}_{v}} exp ( σ ( {A}_{w v} \cdot {a}^{T} [ {W}^{s} {x}_{w} \vert \vert {W}^{s} {x}_{v} ] ) )}$$

In equation (1), above, [symbol] ={u∈ [symbol] : (u,v)∈Eₜ} can be a set of immediate neighbors of node v in the graph snapshot, W^{s}∈ [symbol] can be a shared weight transformation applied to each node in the graph snapshot. In terms of FIG. 4, an analysis computer can apply different linear transformations at steps 402, 404, and 406 to the query Q, the keys K, and the values V, respectively. The linear transformations can be any suitable linear transformation applied to the query Q, the keys K, and the values V. In equation (1), the linear transformations may be applied, for example, by the shared weight transformation W^{s}∈ [symbol] . a∈ [symbol] can be a weight vector parameterizing the attention function implemented as feed-forward layer.

At step 408, the analysis computer can concatenate the linearly transformed query Q and keys K into a matrix or vector. In some embodiments, at step 410, an additional linear transformation may be applied to the concatenated matrix. For example, in equation (1), ∥ can be a concatenation operation, which can concatenate the linearly transformed query Q and keys K.

Aᵤᵥ can be the weight of link (u, v) in the current graph snapshot [symbol] . The set of learned coefficients αᵤᵥ, obtained by a softmax over the neighbors of each node (e.g., at step 412), can indicate an importance or contribution of a node u to a node v in the current graph snapshot. In some embodiments, an analysis computer can utilize sparse matrices to implement a masked self-attention over neighbor nodes.

At step 414, the analysis computer can perform a Matmul process (e.g., matrix multiplication) on the linearly transformed values V (from step 406) as well as the output of step 412. For example, the analysis computer can multiply the learned coefficients, the shared weight transformation, and the correspondent input node representations of a neighboring node (e.g., αᵤᵥW^{s}xᵤ) to determine a value for each of the set of immediate neighboring nodes of node v. The analysis computer can determine a sum of these values which may indicate a weight of each neighboring node's influence on the node v. Then the analysis computer can apply an activation function to the summed value. For example, in equation (1), σ(⋅) can be a non-linear activation function. For example, in artificial neural networks, an activation function of a node can define an output of that node given an input or set of inputs. The output of the activation function, for example, can include a value ranging from 0 to 1.

As an example, in terms of a self-attention mechanism which translates sentences from one language to another, the query Q can be an input sentence which can be translated. The keys K can be a hidden encoder state. For example, the keys K may be words (in a vector format) which relate to the input query Q sentence. The values V can then be values determined by the keys K and attention scores given to each of the keys K. In some embodiments, the query Q can include a particular node in a graph snapshot. The keys K can include the neighboring nodes (e.g., nodes connected via edges) to the node of the query Q. The values V can be attention scores for the connections between the node of the query Q and the neighboring nodes of the keys K.

As another example, a query vector, a key vector, and a value vector can be created. These vectors can be created by multiplying the embedding by, for example, three matrices that are trained during a training process. In some embodiments, calculating attention may be performed by first, taking the query and each key and compute the similarity between the two to obtain a weight. The analysis computer can utilize any suitable similarity function, for example, dot product, splice, detector, etc. Then the analysis computer can use a softmax function to normalize these weights, and can weight these weights in conjunction with the corresponding values and obtain the final attention.

In some embodiments, the analysis computer can additionally employ multi-head attention (Vaswani et al., 2017) to jointly attend to different subspaces at each input, leading to a leap in model capacity. Embodiments can use multiple attention heads, followed by concatenation, in the graph structural learning layer, as summarized below:

hᵥ=Concat(zᵥ¹,zᵥ², . . . ,zᵥ^{H}) ∀v∈V

In the above equation, h can be a number of attention heads. hᵥ∈ [symbol] can be the output of structural multi-head attention. Structural attention can be applied on a single snapshot.

A multi-head attention process can compute multiple attention weighted sums rather than a single attention pass over the values. To learn diverse representations, multi-head attention can apply different linear transformations to the values, keys, and queries for each head of attention. A single attention head can apply a unique linear transformation to its input queries, keys, and values. Then, the attention score between each query and key can be computed and then used to weight the values and sum them. Then, the output of the attention process can be concatenated for each head of attention that is performed.

Further details regarding FIG. 4 can be found in [Ashish Vaswani et al., In Advances in Neural Information Processing Systems 30: Annual Conference on Neural Information Processing Systems 2017, 4-9 Dec. 2017, Long Beach, CA, USA, pp. 6000-6010, 2017.], which is incorporated herein by reference for all purposes.

D. Temporal Convolution

The node representations computed by the structural block can be input to a temporal convolution layer, which can compute one or more temporal convolutions independently for each node v over a series of time steps with a different time windows (e.g., over different series of graph snapshots). In some embodiments, the temporal convolution layer can characterize a node at a point in time and how the node relates to itself at other points in time (e.g., within a certain time window).

The temporal convolution module 208B, which may more generically be referred to as a temporal sequence learning module, aims to capture the temporal evolution of dynamic graphs. The module can utilize lightweight convolution [Wu et al., 2019], which summarizes the learnt structural information of each historical graph snapshot into a unified representative embedding. A major advantage of applying lightweight convolution is efficiency. Lightweight convolution, which is a form of depthwise convolution, only aggregates information from the temporal perspective, and thereby avoids unnecessary higher-order feature interactions that are already well-performed by the Graph Structure Learning module. In addition, lightweight convolution shares weights across certain channels, and thereby further reduces the number of parameters, which alleviates computational cost and regularizes the model.

For each node v, the input to the temporal convolution layer can be the output from the graph structure learning module. For example, for each node v, the input can be the values for each specific dimension from a set of intermediate vector representations {zᵥ^{1,l-1}, zᵥ^{2,l-1}, . . . , zᵥ^{T,l-1}∈ [symbol] , 1≤t≤T} where T can be a number of time-steps (e.g., graph snapshots), and D can denote a specific dimension of the input vector representations. Where l−1 indicates that these are the values before temporal convolution takes place.

The output of the temporal convolution layer can be a new set of vector representations (e.g., final node representations) for each node v at each time step (e.g., zᵥ={zᵥ^{1,l}, zᵥ^{2,l}, . . . , zᵥ^{T,l}}, zᵥ^{t,l}∈ [symbol] with dimensionality D, where l indicates that these are the values after temporal convolution takes place). The input embedding representations of v, packed together across all graph snapshots, can be denoted by the matrix Zᵥ^{l-1}∈ [symbol] . The output embedding representations of v, packed together across all graph snapshots, be denoted by matrix Zᵥ^{l}∈ [symbol] respectively.

An objective of the temporal convolution layer can be to capture the temporal variations in graph structure over multiple time steps. The input vector representation of the node v at time-step t, zᵥ^{t}, can constitute an encoding of the current local structure around v. zᵥ^{t} can be convoluted with its time-neighboring representations (e.g. zᵥ^{t+1}, zᵥ^{t-1}, etc.), thereby allowing the local time-neighborhood around zᵥ^{t} to have an impact on zᵥ^{t}. Thus, temporal convolution facilitates learning of dependencies between various representations of a node across different time steps.

I. Depthwise Convolution

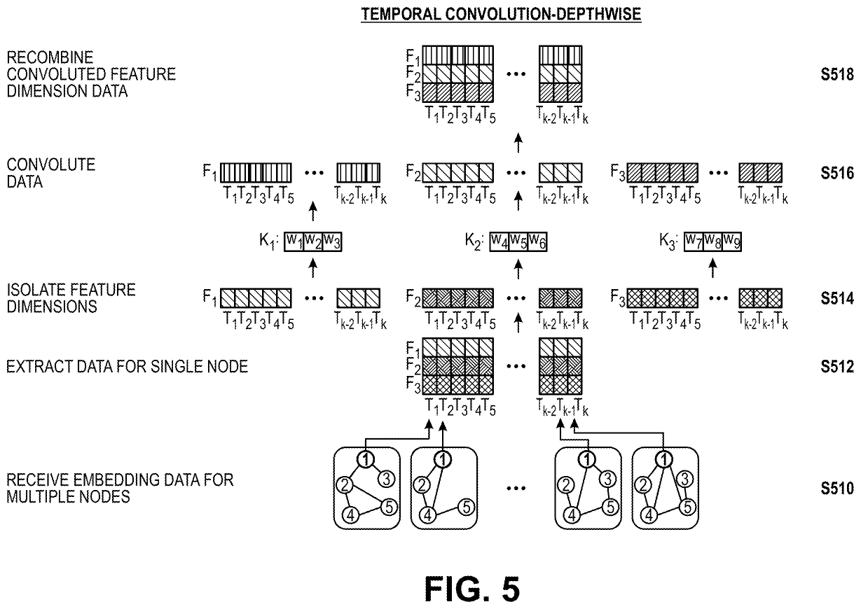

FIG. 5 shows a flow diagram illustrating a method of depthwise temporal convolution, according to some embodiments. As discussed above, the inputs can be node representations (e.g., intermediate vector representations of each node) computed by the structural block. Typically, each node will be processed and convoluted individually with different snapshot vector versions of itself. The illustration in FIG. 5 shows the process for temporal convolution of a single node embedding. This process can be performed for each node embedding.

At step S510, the data to be convoluted can be received by, for example, a temporal convolution module 208B of the analysis computer 200. The data can include a plurality of different time snapshots, where each snapshot includes a plurality of node representations determined by the structural block. As discussed above, these may be the intermediate vector representations of each node.

At step S512, information for a single specific node embedding can be retrieved from within the dataset which has a plurality of node embeddings. The data for the single node embedding can include various versions of the node embedding (e.g., intermediate vector representations of the node) across different time snapshots (e.g., t₁, t₂, . . . , tₖ). At each time snapshot, the node embedding can be described by a set of feature dimension values. The example in FIG. 5 shows three feature dimensions: F₁, F₂, and F₃. A value for each feature dimension at each time snapshot is represented by a box in the figure. Accordingly, a first node is described by a first set of feature values for each feature dimension across a set of timestamps. These feature values can be referred to as first feature values, as the convolution process will use to provide a new set of second feature values for each feature dimension across the set timestamps.

At step S514, feature values for each of the plurality of feature dimensions can be separated and isolated. For example, a set of timestamp-specific feature values for the first feature dimension F₁ can be retrieved (e.g., values for F₁ at t₁, t₂, . . . , tₖ), a set of timestamp-specific feature values for the second feature dimension F₂ can be retrieved (e.g., values for F₂ at t₁, t₂, . . . ,tₖ), a set of timestamp-specific feature values for the third feature dimension F₃ can be retrieved (e.g., values for F₃ at t₁, t₂, . . . , tₖ).

At step S516, temporal convolution can be performed separately for each feature dimension of the plurality of features dimensions (further to each node being temporal convoluted separately). The temporal convolution can be performed using the separated feature dimension values and corresponding convolution kernels from a plurality of convolution kernels. As shown, there can be a plurality of convolution kernels, and each feature dimension can be associated with a different corresponding convolution kernel from the plurality of convolution kernels. Feature dimension F₁ can be convoluted using kernel K₁, feature dimension F₂ can be convoluted using kernel K₂, and feature dimension F₃ can be convoluted using kernel K₃.

Each kernel may have a certain predefined length (or number of values). In this example, each kernel has three values (e.g., a window or length of three). For example, the first kernel K₁ has values w₁, w₂, and w₃, the second kernel K₂ has values w₄, w₅, and w₆, and the third kernel K₃ has values w₇, w₈, and w₉. However, embodiments allow the kernel to have any suitable length or number of values (e.g., 2, 3, 4, 5, 6, 7, 8, 9, or 10 values). The kernel values can be normalized trainable weight parameters which can be trained during a training process (e.g., a machine learning process), as described in more detail below.

The kernel values may reflect the influence that the value of certain feature dimension at previous snapshot has on a that feature dimension at a current snapshot, and can thereby be a tool for giving attention to certain values of the feature dimension from certain previous snapshots. Accordingly, the length of the kernel can determine how many recent snapshots should be considered when transforming a current feature dimension for a current snapshot.

To perform depthwise convolution, a kernel can be applied to the feature values of a corresponding feature dimension. The kernel can be applied multiple times, each time applied to a different subset of feature values, each subset of feature values being consecutive (e.g., belonging to consecutive timestamps). For example, a series of dot product calculations can be performed using the kernel weight parameter values and the feature dimension values (e.g., the first feature values for the feature dimensions). Each dot product calculations can utilize a subset of feature values. Using the first feature dimension F₁ as an example, a dot product can be calculated using the kernel K₁ and a first subset of three consecutive feature values of the feature dimension F₁ (e.g., the F₁ values for the first three consecutive timestamps t₁, t₂, and t₃). This produces a result that is a single scalar value. The result can be utilized as a temporal convoluted feature value (also referred to as a second feature value or a final feature value) for a certain timestamp, which may be the last (or right-most) of the consecutive input timestamps (e.g., t₃) in some embodiments. A second dot product can be calculated using the kernel K₁ and a second subset of three consecutive feature values of the feature dimension F₁ (e.g., the F₁ values for the second, third, and fourth consecutive timestamps t₂, t₃, and t₄). This produces another scalar value result. This second result can be utilized as a temporal convoluted value (also referred to as a second feature value or a final feature value) for the next timestamp (e.g., t₄), in some embodiments. A third dot product can be calculated using the kernel K₁ and a third subset of three consecutive feature values of the feature dimension F₁ (e.g., the F₁ values for the third, fourth, and fifth consecutive timestamps t₃, t₄, and t₅). This produces a third result that is a third scalar value, which can be utilized as a temporal convoluted value (also referred to as a second feature value or a final feature value) for the subsequent snapshot (e.g., t₅) in some embodiments.

Dot product calculations can continue in this manner until the end of the feature values of the first feature dimension F₁ at the last time snapshot tₖ. As a visual representation of this process, in FIG. 5, the kernel K₁ can be overlaid on the feature dimension F₁. The dot product can be taken between the kernel K₁ and the overlaid subset of feature values of the feature dimension F₁. Then, the kernel K₁ can slide one value to the right on the feature dimension F₁, and another dot product can be taken with that subset of feature values. The kernel K₁ can continue sliding to the right until the end of the feature dimension F₁. The results, when concatenated, provide a new set of feature values for the feature dimension F₁ across the set of timestamps. The new values can be referred to as second feature values or final feature values for the feature dimension F₁. Taken together, the second feature values across the timestamps comprise the temporal convoluted version of the feature dimension F₁ (e.g., for the first node).

In some embodiments, the feature dimension F₁ can be padded with one or more empty values at the beginning (e.g., before time t₁). This can be done to ensure that the temporal convoluted version of the feature dimension F₁ has the same length or number of values as the original feature dimension F₁. For example, if the dot product result is used as the convoluted value of the last input snapshot for that dot product, then the first overlay of the kernel K₁ on the feature dimension F₁ produces a convoluted value for the third time snapshot t₃. In order to produce convoluted values for the first and second time snapshots, the kernel slides to the left onto an area where there are no feature dimension values. Accordingly, empty values (e.g., zero) can be padded to the left, so that the dot product can be still be taken with the kernel. This can produce convoluted values for the first and second time snapshots, and thereby maintain the same number of values for the total convoluted feature dimension F₁.

As shown in FIG. 5, this kernel dot product process for depthwise convolution can be performed for each feature dimension and their corresponding kernels.

At step S518, the convoluted feature dimension data can be recombined to recreate the different timestamp-specific versions of the node embedding, but now the node embedding is temporal convoluted. Each of the different feature dimension values can be assembled according to the timestamp (also referred to as a time snapshot or time-step) with which it is associated. For example, the new feature value (also referred to as the second feature value or final feature value) for Feature dimension F₁ at the first timestamp t₁, the new feature value for Feature dimension F₂ at the first timestamp t₁, and the new feature value for Feature dimension F₃ at the first timestamp t₁ can be assembled to create the temporal convoluted embedding (also referred to as vector representation) of the first node for the first timestamp t₁. As a result, an output vector is created that is representative of the change in the local structure of the node over time (e.g., over the same number of time-steps as the length of the kernel). This can be referred to as the final vector representation of the node at that timestamp (e.g., the first timestamp t₁). Final vector representations can be assembled for each timestamp, thereby creating a set of final vector representations of the first node, each vector representation corresponding to a different timestamp. Thus the final vector representations are produced for the first node.

This process can be performed for each node embedding. Mathematically, the total depthwise convolution process across each node with each kernel can be described by the following formula:

$${O}_{i , c} = Depthwise Conv ( X , {W}_{c , :} , i , c ) = {\sum }_{j = 1}^{k} {W}_{c , j} \cdot {X}_{( i + j - ⌈ \frac{k + 1}{2} ⌉ ) , c}$$

Once completed, the node embedding information can include both structural and temporal information. As an example, an academic co-authorship network may include multiple authors that periodically switch their collaboration behaviors. The node embedding can include structural information for each time-step snapshot. The structural information can incorporate author interactions and author characteristics based on the author's behavior at that time (e.g., which authors have collaborated). The temporal information can indicate an evolutionary pattern for author behavior. For example, if the temporal convolution used a kernel of length 3, an author's embedding at a certain time-step can be transformed based on convolution with the previous two time-step snapshot versions of that author's embedding, and thereby trace evolutionary patterns of behavior.

The node embedding information that includes both structural and temporal information be useful for making predictions of future events, such as whether two authors will collaborate (e.g., an edge will connect their two nodes) at a future time. The prediction process is discussed in more detail below.

II. Lightweight Convolution

Additional and alternative methods of convolution can be utilized, according to some embodiments. For example, lightweight convolution is a specific type of depthwise convolution, where some of the kernel weights can be shared among certain feature dimensions. In FIG. 5, the depthwise convolution process used a different kernel for each feature dimension. In contrast, lightweight convolution can utilized a certain kernel across multiple feature dimensions. Repurposing a kernel for multiple feature dimensions can reduce data processing loads, as the number of kernel weight parameters to determine through machine learning processes is reduced.

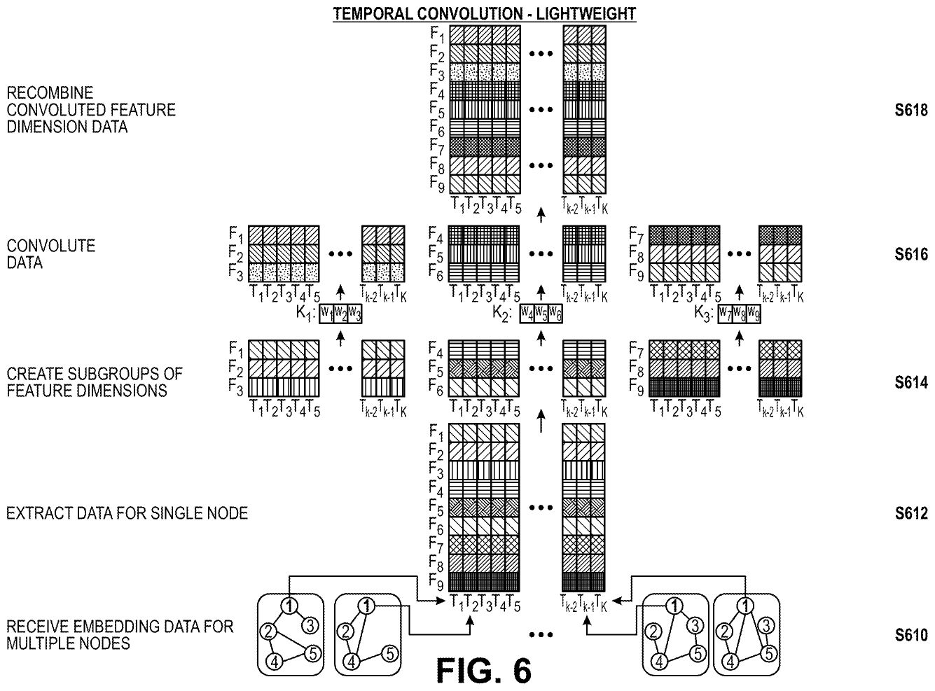

FIG. 6 shows a flow diagram illustrating a method of lightweight temporal convolution, according to some embodiments.

At step S610, which can be the same as or similar to step S510 in FIG. 5, the dataset to be convoluted can be received. The data can include a plurality of different time snapshots, where each snapshot includes a plurality of node representations determined by the structural block.

At step S612, which can be the same as or similar to step S512 in FIG. 5, information for a single specific node embedding can be retrieved from within the dataset which has a plurality of node embeddings. In this example, the node embedding has nine feature dimensions: F₁, F₂, F₃, F₄, F₅, F₆, F₇, F₈, and F₉.

At step S614, which can be similar to step S514 in FIG. 5, values for each of the feature dimensions can be separated. Instead of isolating each feature dimension, subgroups of feature dimensions can be formed. For example, a first subgroup can include feature dimensions F₁, F₂, and F₃, a second subgroup can include feature dimensions F₄, F₅, and F₆, and a third subgroup can include feature dimensions F₇, F₈, and F₉.

At step S616, which can be similar to step S516 in FIG. 5, temporal convolution can be performed for each feature dimension separately based on the separated feature dimension values and corresponding kernels. Similar to step S516 in FIG. 5, each feature dimension can be convoluted individually. Different than step S516 in FIG. 5, certain kernels can be utilized for more than one feature dimension. For example, the first kernel K₁ can be used to convolute each of the first subgroup (e.g., feature dimensions F₁, F₂, and F₃), the second kernel K₂ can be used to convolute each of the first subgroup (e.g., feature dimensions F₄, F₅, and F₆), and the third kernel K₃ can be used to convolute each of the third subgroup (e.g., feature dimensions F₇, F₈, and F₉).

In this example, the kernel are again shown to have a length or three values. However, embodiments allow the kernel to have any suitable length or number of values. The kernel values can be normalized trainable weight parameters which can be trained during a training process (e.g., a machine learning process). The kernel values may be determined by attending over the feature dimensions of different intermediate vector representations of the same node from neighboring time snapshots. Accordingly, the kernel parameter values can indicate relevance of previous snapshot values for a feature dimension. The kernel length establishes the number of previous snapshots that are considered. The kernel length may be considered a hyper-parameter, and may be selected through experimentation. For example, a larger kernel may capture more long-term temporal relationships, and as a result may provide more accurate results in when the number of graph snapshots is large. However, a larger kernel also increases the computational complexity of the model. Experiments are discussed below regarding testing for an optimal kernel size that captures sufficient temporal information without overdue computational complexity.

At step S618, which can be the same as or similar to step S518 in FIG. 5, the convoluted feature dimension data can be recombined to recreate the node embedding, now temporal convoluted. Each of the different feature dimension values can be assembled according to the time snapshot with which it is associated. For example, the values for feature dimensions F₁, F₂, and F₃ from the first subgroup at the first time snapshot t₁, the values for feature dimensions F₄, F₅, and F₆ from the second subgroup at the first time snapshot t₁, and the values for feature dimensions F₇, F₈, and F₉ from the third subgroup at the first time snapshot t₁ can be assembled to create the temporal convoluted embedding of the first node for the first time snapshot t₁.

This process can be performed for each node embedding. Mathematically, the lightweight convolution process can be described as a modification of the depthwise convolution formula:

$$Light Conv ( X , {W}_{⌈ \frac{cH}{d} ⌉ , :} , i , c ) = Depthwise Conv ( X , softmax ( {W}_{⌈ \frac{cH}{d} ⌉ , :} ) , i , c ) \qquad ( 2 )$$

Where the softmax function is used to normalize the weight parameters, and can take the following form:

$$softmax {( W )}_{h , j} = \frac{exp {W}_{h , j}}{{\sum }_{{j}^{′} = 1}^{k} exp {W}_{h , {j}^{′}}}$$

Once completed, the temporal convoluted node embedding information can be used to make predictions of future events, as discussed in more detail below.

III. Additional Modules

In some embodiments, temporal sequence learning can include additional processing functions that are used in combination with convolution (e.g., depthwise or lightweight). For example, gated linear units, feed-forward layers, residual connections, softmax normalization operations, and/or any other suitable tools can be used to improve the temporal convolution process.

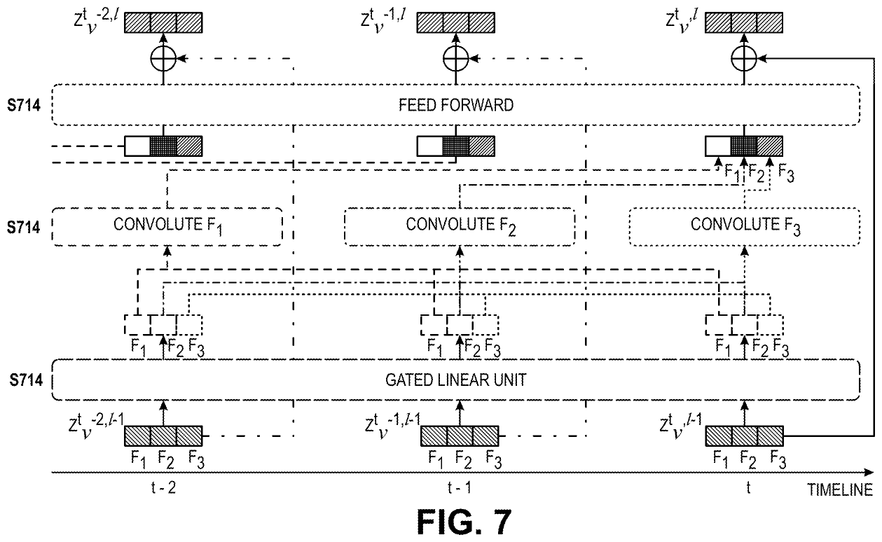

FIG. 7 shows a flow diagram illustrating a method of temporal sequence learning with additional module processes, according to some embodiments. As discussed above, the inputs can be node representations computed by the structural block. Typically, each node will be processed and convoluted individually with different snapshot versions of itself. Zᵥ^{t,l-1} can include all feature dimension values (e.g., as provided by the structural block) of a single node v at a time-step t before being convoluted (as indicated by l−1). Zᵥ^{t-1,l-1} can represent the values of the same node embedding, but at one time-step earlier (t−1) than Zᵥ^{t,l-1}. Similarly, Zᵥ^{t-2,l-1} may be two time-steps earlier than Zᵥ^{t,l-1}.

In some embodiments, in addition to convolution, a gated linear unit (GLU) [Dauphin et al., 2017] can also be utilized to enhance the model's prediction capability. The GLU can beneficially filter out uninformative dimensions and time steps. For example, in some embodiments, at step S710, the input values Zᵥ^{t,l-1} can be first be fed into the GLU, which may take the following form:

I^{l}=(Zᵥ^{l-1}*Wₐ^{l}+a)⊗σ_{glu}(Zᵥ^{l-1}*W_{b}^{l}+b)

In the above equation, Wₐ^{l},W_{b}^{l}∈ [symbol] , a,b∈ [symbol] are the learnable parameters, σ_{glu} is the sigmoid function, and ⊗ is the hadamard product

At step S712, the output of the GLU from step S710 can be used for the convolution process. For example, the feature dimension values F₁, F₂, and F₃, can be aggregated separately across the time-steps, and then processed separately using corresponding kernels (e.g., as discussed above with respect to FIGS. 5 and 6).

As discussed above, embodiments can utilize depthwise convolution. In mathematical terms, depthwise convolution can involve using a weight matrix to transform the input data (e.g., output from step S710). The input data can be expressed as a matrix with dimensions defined by the number of snapshots and the number of feature dimensions for the node in each snapshot:

I^{l}∈

[symbol]

The weight matrix can be expressed as a matrix with dimensions defined by the length of the kernal and number of feature dimensions for the node in each snapshot (e.g, due to using a different kernel for each feature dimension):

Θ^{l}∈

[symbol]

Where K is the convolution kernel length (e.g., the number of different kernel parameter values). This can produce, for the time step t and output dimension c, a depthwise convolution output matrix output with the same dimensions as the input matrix:

Ô^{l}∈

[symbol]

In total, depthwise convolution performed upon data received from the GLU process can be expressed as the dot product of the input data matrix and the weight matrix:

$${\hat{O}}_{t , c}^{l} = Dep Conv ( {I}^{l} , {Θ}_{c , :}^{l} , t , c ) := {\sum }_{i = 1}^{K} {Θ}_{c , i}^{l} \cdot {\hat{I}}_{t + i - K , c}^{l}$$

Embodiments can include a padded input matrix by padding K−1 rows of all-zero vectors before the 1st row of I^{l}. Unlike traditional depthwise convolution that positions the convolution kernel in the middle of the targeted index, embodiments can utilized a right-aligned kernel. This can encode temporal order in a way that prevents absorbing future information for current prediction. Thus, a right-aligned kernel can absorb historical information into a current time-step, and can avoid having relative future data reflect back onto the current time-step. The padded input matrix can be expressed as:

Î^{l}∈

[symbol]

As discussed above, embodiments can utilize lightweight convolution. Lightweight convolution [Wu et al., 2019], is a specific type of depthwise convolution that shares weights on certain channels. This can further reduce the module's space complexity. The output of lightweight convolution can be expressed as:

O^{l}∈

[symbol]

In total, lightweight convolution performed upon data received from the GLU process can be expressed as:

$${O}_{t , c}^{l} = LW Conv ( {I}^{l} , {Θ}_{⌈ \frac{c {H}^{l}}{{D}^{l}} ⌉ , :}^{l} , t , c ) = Dep Conv ( {I}^{l} , {Θ}_{⌈ \frac{c {H}^{l}}{{D}^{l}} ⌉ , :}^{l} , t , c )$$

where H^{L} denotes the number of convolution kernels, which reduces the number of parameters by a factor of

$$\frac{{D}^{l}}{{H}^{l}} .$$

In contrast, with the original lightweight convolution proposed in [Wu et al., 2019], some embodiments can exclude the softmax normalization in order to keep the raw weights. Additionally, embodiments can exclude adding positional encoding as positional information can be encoded in convolution layers. [Islam et al., 2020].

In some embodiments, in addition to convolution, a residual connection can also be utilized to enhance the model's prediction capability. For example, in some embodiments, at step S714, the output of the convolution from step S712 can be recombined into a single vector, effectively feeding forward information from previous time-steps into the current time-step being convoluted. Then the convoluted values can be input into a residual connection, which can take the form of:

Zᵥ^{l}=σ_{ƒc}(O^{l}*W_{ƒ}^{l})+Zᵥⁱ⁻¹

Where Zᵥ^{l} is a final output matrix for embedding representations of the node v at different time steps, and where σ_{ƒc} is the ReLU activation function. The weight matrix can be expressed as:

W_{ƒ}^{l}∈

[symbol]

In some embodiments, the temporal convoluted embedding representations can be feedback into the beginning of the temporal convolution module and processed again. The temporal convolution process can be performed any suitable number of times (e.g., 1 time, 2 times, 3 times, etc.) upon the same embedding data. This can effectively incorporate more time-steps into the convolution. For example, if the first convolution uses a kernel of length 3, then two previous time-steps are used to modify a current time-step through convolution. If each time-step is convoluted a second time, then the two previous time-steps being used to convolute the current time step have now been modified by even earlier time-steps (e.g., four and five time-steps earlier), and those even earlier time-steps can now have an effect on the current time step.

The neural architecture according to embodiments, can use the above defined graph structural learning layer and temporal convolution layer as modules. FIG. 8 shows a flow diagram illustrating a DyCLN architecture according to some embodiments. As shown in FIG. 8, embodiments can have three modules from top to bottom, (1) a structural attention block (e.g., including 810-834), (2) a temporal convolution block (e.g., including 840, 852, 862, and 872), and (3) graph context prediction (e.g., including 854, 864, and 874). The analysis computer can accept, as input, a collection of T graph snapshots, and can generate output latent node representations (e.g., intermediate vector representations) at each time step.

The graph structural learning block module can include multiple stacked structural self-attention layers to extract features from nodes at different distances. Each layer can be applied independently at different snapshots with shared parameters, as illustrated in FIG. 8, to capture local neighborhood structure around a node at each time-step (e.g., graph snapshot). However, the values input to a layer can potentially vary across different graph snapshots as the graph may change over time. The vector representations output by the structural attention block, can be denoted as {hᵥ¹, hᵥ², . . . , hᵥ^{T}}, hᵥ^{t}∈ [symbol] , which can feed as input to the temporal attention block.

For example, FIG. 8 illustrates three graph snapshots, including a first graph snapshot 810, a second graph snapshot 820, and a third graph snapshot 830. The first graph snapshot 810 can be a portion of a dynamic graph at time 1. In some embodiments, time 1 can be a time range (e.g., 8/11/2021 to 8/17/2021). The second graph snapshot 820 can be a portion of the dynamic graph at time 2. The third graph snapshot 830 can be a portion of the dynamic graph at time T. The dynamic graph may include graph data which may be, for example, communication graph data. For example, each node of the first graph snapshot 810 can represent an email address of a user. The edges connecting the nodes in the first graph snapshot 810 can indicate a communication between the users of the two email addresses. In the first graph snapshot 810, the node V can be connected to the nodes 2 and 3 via edges. This may correspond to a situation in which the email address of node V received and/or emails from email addresses associated with nodes 2 and 3.

Over time, as indicated in subsequent graph snapshots, the structure of the dynamic graph may change. For example, new edges may be created when two email addresses communicate with one another when they previously did not communicate and new nodes may be created as new email addresses are created. Further, nodes and edges can be removed as email addresses are deactivated and when two email addresses cease to communicate.

Each node of each graph snapshot may be associated with one or more characteristics. For example, a node which indicates an email address of a user can have characteristics of a local-part, a domain, a character length, a sub-address, etc. For example, the characteristics of node 2 can be illustrated by characteristics 812 and can differ from the characteristics of node V. Similarly, the node V in the third graph snapshot 830 can have neighboring nodes 3 and 4, which may be taken into account when determining an intermediate vector representation for time T.

The dashed arrows (e.g., arrow 813) can indicate which nodes (e.g., neighboring nodes) can be taken into account when performing a self-attentional process on a given node. For example, the node V in the first graph snapshot 810 can have neighboring nodes 2 and 3, which may be taken into account when determining an intermediate vector representation for the node V.

The analysis computer can extract a plurality of first datasets from a plurality of graph snapshots using a graph structural learning module as described herein. The plurality of first datasets can include intermediate vector representations 814, 824, and 834 for each node for each snapshot of the plurality of graph snapshots (e.g., the first graph snapshot 810, the second graph snapshot 820, and the third graph snapshot 830). Each dataset of the plurality of first datasets can comprise a plurality of vectors. In some embodiments, the intermediate vector representations 814 can include any suitable number of vectors. In some embodiments, there may be one vector for each node of the corresponding graph snapshot.

For example, the analysis computer can determine first intermediate vector representations 814 (denoted as hᵥ¹) of the first graph snapshot 810. The first intermediate vector representations 814 can be determined by embedding the nodes of the first graph snapshot 810 using a self-attentional neural network. For example, the analysis computer can analyze the node V of the first graph snapshot 810. The analysis computer can determine a vector representative of the node V and neighboring nodes 2 and 3 using equation (1), above. In some embodiments, the vector can have fewer dimensions than the node V. For example, the node V and the neighboring nodes can be input into an embedding self-attentional neural network to determine an output (e.g., intermediate vector representations) which represents the structure of the node V and the surrounding neighbor nodes 2 and 3.

The analysis computer can determine intermediate vector representations corresponding to each graph snapshot separately. The analysis computer can determine intermediate vector representations for any suitable number of graph snapshots. For example, the analysis computer can determine intermediate vector representations from each graph snapshot that has been recorded and/or measured and then stored in a graph data database. In some embodiments, the analysis computer may have previously determined intermediate vector representations, in which case, the analysis computer can retrieve the intermediate vector representations from a database.

In some embodiments, after extracting the first intermediate vector representations 814 from the first graph snapshot 810, the analysis computer can apply positional embeddings to the intermediate vector representations in order to equip the intermediate vector representations with a sense of ordering. For example, the module can be equipped with a sense of ordering through position embeddings (Gehring et al., 2017), {p¹, . . . , p^{T}}, p^{T}∈ [symbol] , which can embed an absolute temporal position of each snapshot. The position embeddings can then be combined with the output of the structural attention block to obtain input representations: {hᵥ¹+p¹, hᵥ²+p², . . . , hᵥ^{T}+p^{T}} for node v across multiple time steps. The input representations being input to the temporal lightweight convolution module 840.

Next, step 840, where the data is input to the temporal lightweight convolution module, will be discussed. The temporal lightweight convolution module can perform some or all of the processes described above with respect to FIG. 7, according to some embodiments. For example, in some embodiments, FIG. 7 may be representative of the temporal lightweight convolution module. This block can also follow a similar structure with multiple stacked temporal convolution layers. The temporal lightweight convolution module 840.

For example, at step 840, the analysis computer can extract at least a plurality of second datasets from the plurality of first datasets using a temporal convolution learning module across the plurality of graph snapshots. The plurality of second datasets can include, for example, final node representations for a plurality of graph snapshots. The plurality of second datasets may include the same number of graph snapshots as the plurality of first datasets. The final node representations can include any suitable number of vector representations of the nodes. In some embodiments, the final node representations can include a plurality of vectors equal to the number of nodes.

The analysis computer can, for example, input the first dataset (e.g., intermediate vector representations), determined from the previously performed structural self-attention neural networks, into second convolutional neural network to determine a second dataset of final vector representations. The first dataset may include determined intermediate vector representations from each previous and current graph snapshot. For example, at time T=2, the first dataset can include intermediate vector representations from the first graph snapshot 810 and the second graph snapshot 820. For example, a first intermediate vector representation, resulting from the node V in the first graph snapshot 810 can be input into the neural network along with the second intermediate vector representation, resulting from the node V in the second graph snapshot 820.

For the node V, the input can be, for example, {xᵥ¹,xᵥ²}, where xᵥ¹ can be an intermediate vector representation of node V at graph snapshot 1 (e.g., 810), and where xᵥ² can be an intermediate vector representation of node V at graph snapshot 2 (e.g., 820). Although one node is discussed, it is understood that the analysis computer can determine an intermediate vector representation of each node of each graph snapshot. This input representation of node V can constitute an encoding of the local structure around the node V. The values of xᵥ^{t} can be the query input for the convolution process, and can be used to convolute over the node V's historical representations, thus tracing the evolution of the values of xᵥ^{t} over time.

For example, between the first graph snapshot 810 and the second graph snapshot 820, the node V representing an email address in a communication network can begin communicating with new email address represented by node 4. Since the analysis computer determined an intermediate vector representation representing the node V's local structure, the changes in the local structure over time can be analyzed.

The temporal lightweight convolution module 840 can determine, via a training process (e.g., neural network learning), weights indicative of how much a portion of a given input relates to the rest of the input. For example, the analysis computer can determine weights indicative of how much a first intermediate vector representation of a first node relates to a plurality of other intermediate vector representations of the first node corresponding to subsequent time snapshots. These weights can then be in convolutional kernels to convolute the intermediate vector representations and produce final vector representations.

For example, a first node representative of a first email address can correspond to three determined intermediate vector representations. Each intermediate vector representation indicative of a local structure of the graph data surrounding the first node. For example, a first intermediate vector representation can indicate the structure around first node during a first week (e.g., based on email interactions that occurred during the first week). The second intermediate vector representation can indicate the structure around first node during a second week (e.g., based on email interactions that occurred during the second week). A third intermediate vector representations can indicate the structure around the first node during a third week (e.g., based on email interactions that occurred during the third week).

The analysis computer can determine weights indicative of the similarity of a portion of the input (e.g., a first intermediate vector representation) by attending over the rest of the input (e.g., the second and third intermediate vector representations). For example, the first week may have a similar local structure as the second week as the user may be continuing email conversations from the first week. The first week may have a different local structure than the third week, as the email conversations from the first week may have been completed. New email conversations may have begun in the second week, and may carry forward into the third week, so the second week may have some similar local structure both to the third week and the first week, even if the first and third week structures are dissimilar. Accordingly, the analysis computer can determine that the second week has a higher weight value in relation to the third week than the first week.

In such a manner, the analysis computer can determine how relevant the email behaviors of the first week and second week are to the third week. For example, the analysis computer may determine that, when considering the third week, the behaviors of the first week has a weight value of 0.1, and the behaviors of the second week have a weight value of 0.3. The third week may also be assigned a relative weight of 0.6, which may indicate how independent the behaviors of the third week are from the previous two weeks.

These week-based weights are given as a conceptual introduction. As discussed above, different weights may actually be determined for each feature dimension for the week, as opposed to a single weight for the node that week. For example, a first set of three weights for the first, second, and third weeks can be determined for a first feature dimension (e.g., email length), a second set of three weights for the first, second, and third weeks can be determined for a second feature dimension (e.g., email time of day), and a third set of three weights for the first, second, and third weeks can be determined for a third feature dimension (e.g., email topic subject matter). The various feature dimension-specific weights can be utilized as kernel values for different feature dimension kernels in the convolution process. Any suitable training process such as machine learning via neural network can be used to determine these kernel weight parameters.

As an additional example, a first node representative of a resource provider can correspond to five determined intermediate vector representations. Each intermediate vector representation indicative of a local structure of the graph data surrounding the first node. For example, a first intermediate vector representation can indicate the structure around first node during the summer (e.g., the time of the graph snapshot is during the summer). Second, third, fourth, and fifth intermediate vector representations can indicate the structure around the first node during fall, winter, spring, and subsequent summer.

The analysis computer can determine weights indicative of the similarity of input value (e.g., a first intermediate vector representation) to the rest of the input (e.g., second, third, fourth, and fifth intermediate vector representations). In this example, the analysis computer can determine a larger weight between the first and fifth intermediate vector representations due to similar local structures around the first node during the summer. For example, the resource provider represented by the first node may transact with a similar number and group of users during the summer, whereas the local structure may decrease (or change in any suitable manner) during the fall, winter, and spring.

In such a manner, the analysis computer can determine how relevant the transaction behaviors of the first summer, the fall, the winter, and the spring are to second summer. For example, the analysis computer may determine that, when considering the second summer, the behaviors of the first summer have a weight value of 0.2, the behaviors of the fall have a weight value of 0.15, the behaviors of the winter have a weight value of 0.1, and the behaviors of the spring have a weight value of 0.15. The second summer may also be assigned a relative weight of 0.4, which may indicate how independent the behaviors of the second summer are from the previous four seasons.

These season-based weights are given as an conceptual introduction. As discussed above, different weights may actually be determined for each feature dimension for the season, as opposed to a single weight for the node that week. For example, a first set of five weights for the first summer, fall, winter, spring, and second summer can be determined for a first feature dimension (e.g., transaction amount), a second set of five weights for the first summer, fall, winter, spring, and second summer can be determined for a second feature dimension (e.g., transaction location), and a third set of five weights for the first summer, fall, winter, spring, and second summer can be determined for a third feature dimension (e.g., type of item purchased). The various feature dimension-specific weights can be utilized as kernel values for different feature dimension kernels in the convolution process. Any suitable training process such as machine learning via neural network can be used to determine these kernel weight parameters.

The analysis computer can, at step 840, determine final node representations for each node at each time-step. For example, the analysis computer can determine a first set of final node representations 852 for the first time-step (e.g., eᵥ¹), a second set of final node representations for the second time-step 862 (e.g., eᵥ²), and a third set of final node representations for the most recent time-step 872 (e.g., eᵥ^{T}) based on the weights determined by a convolutional neural network.

The final node representations can be determined, for example, by performing a convolutional operation on the intermediate vector representations using dimension feature-specific kernels with kernel weight parameters. The final node representations for each time-step can then be compiled to create a second dataset.

For example, to determine a final value for a first feature dimension value of a first node at time-step 3, the kernel for that feature dimension can be applied to the intermediate values for that feature dimension from time-steps 1, 2, and 3 (e.g., if the kernel has a length of 3). This can include calculating a dot product of the three intermediate values with the three kernel weights. As an example, the first feature dimension is email length in characters. The intermediate value for that feature dimension is 400 characters, 200 characters, and 300 characters for the first time-step, second time-step, and third time-step respectively, and the kernel weights are 0.1, 0.2, and 0.7. The dot product produces would then produce a final value of 290 characters. This final value would be utilized as the final feature-dimension for the third time-step (e.g., replacing the intermediate value of 300 characters). This convolution process can be performed for feature dimension of each node at each time-step. As a result, an intermediate node representation can transformed by being combined with a set of previous versions of the same node representation on a weighted feature-by-feature basis.

Conceptually, performing this convolution to transform intermediate node representations into final node representations can be considered similar to performing the task of influencing a current time-step with the values from recent time-steps (e.g., the two previous time-steps when the kernel is length 3). The intermediate node representation may be based only on activities and interactions that happened during that timeframe (e.g., that week, season, etc.) By convoluting to provide a final node representation, past activities and interactions from previous timeframes are considered and incorporated into the present timeframe, even if they are given less weight (e.g., dependent upon the kernel weight values). The intermediate node representation is made somewhat more similar to, or in vector space moved toward, the previous intermediate node representations. This effectively moves the vector back toward previous versions, or can be viewed as reducing or slowing the vector's movement toward new positions as time moves forward. The magnitude of intermediate node representation transformation and movement toward previous versions (e.g., the relevance of the past) is given by the kernel weight values. As a result, a final node representation can be created based on a longer timeframe that includes multiple snapshots with varying local structures, and the different snapshots can be attributed a different amount of impact based on the kernel weight values.

Thus, the final node representations eᵥ^{t} can be vectors which represent the changes in the node's local structure over time, the amount of time being based on the length of each time-step and the length of the convolution kernel. For example, a final node representation corresponding to the node V can include a vector which indicates the addition of communications with node 4 at the second graph snapshot 820 and the removal of node 2 at the third graph snapshot 830.

In some embodiments, the analysis computer can determine a plurality of final node representations for a plurality of snapshots. Each final node representation for each snapshot can correspond to a node of the graph data. These vectors can then be used in any suitable local graph context prediction process. For example, in some embodiments, the analysis computer can train a neural network, SVM, etc. using the final node representations. The analysis computer can train a machine learning model as known to one of skill in the art.

Next, graph context prediction will be discussed. In some embodiments, to ensure that the learned representations capture both structural and temporal information, embodiments can define an objective function that preserves the local structure around a node, across multiple time-steps.

Embodiments can use the dynamic representations of a node v at time-step t (e.g., eᵥ^{t}) to predict the occurrence of nodes appearing the local neighborhood around a node v at a time t. For example, in some embodiments, the analysis computer can use a binary cross-entropy loss function at each time-step to encourage nodes, co-occurring in fixed-length random walks, to have similar vector representations. For example, as given by:

$${L}_{v} = {\sum }_{t = 1}^{T} {\sum }_{u ∈ {𝒩}_{rw}^{t} ( v )} - log ( σ ( < {e}_{u}^{t} , {e}_{v}^{t} > ) ) - Q \cdot {\sum }_{{v}_{n} ∈ {P}_{n}^{t} ( v )} log ( 1 - σ ( < {e}_{{v}_{n}}^{t} , {e}_{v}^{t} > ) )$$

In the equation above, σ can be a sigmoid function, [symbol] (v) can be a set of nodes that co-occur with a node v on a fixed-length random walk at a graph snapshot at time t. Pₙ^{t} can be a negative sampling distribution for the graph snapshot [symbol] , and Q can be a negative sampling ratio. The negative sampling ration can be a tunable hyper-parameter to balance positive and negative samples.

At step 854, 864, and 874, the analysis computer can determine a prediction regarding one or more nodes at a future time (e.g., in a future graph snapshot). This can be done using classification and/or regression models. For example, the analysis computer can determine whether or not two nodes will be connected to one another via an edge based on a model trained on the final node representations eᵥ^{t}. The steps 854, 864, and 874 may together represent combining the final node representations eᵥ^{t} from each step into a second dataset and using the second dataset to make a prediction (e.g., using classification and/or regression models).

The model can include any suitable machine learning model. The analysis computer can perform any suitable prediction based on the context of the graph data. For example, analysis computer can use a trained neural network, trained on the final node representations, to perform graph context prediction. As an illustrative example, the second dataset can be used as input for machine learning models, such as a regression model or a classification model, to make a prediction, such as whether two nodes will be linked or a class a node will belong to.

As an example, the second dataset may correspond to graph data comprising nodes representative of email address. The graph data can include three graph snapshots, each graph snapshot including email interaction data during a week. Final node representations of a first node (e.g., for a first email address) can represent an evolution in graph structure over recent time-steps. For example, a final node representation of the first node at a third time-step can represent the evolution over the previous two time-steps. This can represent the user's evolution of starting, pending, and finishing email conversations through the first email address, as described above.

The analysis computer can then determine a prediction regarding the first email address. For example, the analysis computer can determine whether or not the first email address will communicate with (e.g., be connected to) a second email address in the fourth week (e.g., fourth graph snapshot). In this example, the analysis computer can predict that the first email address will be connected to the second email address in the fourth graph snapshot due to the connections between the first and second email addresses in previous graph snapshots for an ongoing email conversation, as well as a low probability that conversation will finish before the fourth graph snapshot.

In some embodiments, a prediction of whether two nodes (e.g., email addresses, authors, etc.) will interact (e.g., be connected by an edge) in a future time graph snapshot can be calculated using the final vector representations of the two nodes. For example, the analysis computer can compute a Hadamard product using two vectors: the first final vector representation of the first node and a second final vector representation of the second node (e.g., vectors corresponding to the latest snapshot). The Hadamard product can be used as a vector representing a potential link between the two nodes. Then, the analysis computer can input the potential link vector into a logistic regression classifier to compute the probability of the link coming into existence. The parameters of this logistic regression classifier can also be trained based on the training data.

The analysis computer can then perform additional processing such as, but not limited to, performing an action based on the prediction. The action can include transmitting a prediction message to another device, determining whether or not a probability value associated with the prediction (determined by the machine learning model) exceeds a predetermined probability threshold, and/or any other suitable processing of the prediction. In one example, the analysis computer can send an advisory notice that a transaction is likely to take place, or that a current transaction being attempted was not likely to take place and may therefore be fraudulent.

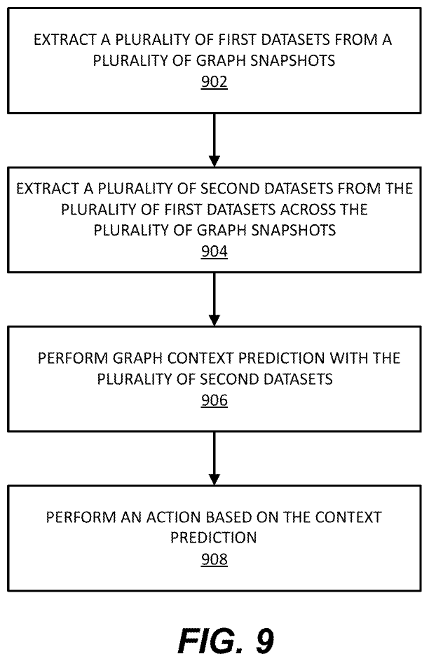

FIG. 9 shows a flow diagram illustrating a dynamic graph representation learning process according to some embodiments. The method illustrated in FIG. 9 will be described in the context of an analysis computer analyzing communication graph data. It is understood, however, that the invention can be applied to other circumstances (e.g., analyzing other types of graph data, etc.). In some embodiments, each graph snapshot of the plurality of graph snapshots can comprise a plurality of nodes. Each graph snapshot of the plurality of graph snapshots can include graph data associated with a timestamp.

At step 902, the analysis computer can extract a plurality of first datasets from a plurality of graph snapshots using a graph structural learning module. The plurality of first datasets can include intermediate vector representations for each node for each snapshot of the plurality of graph snapshots. In some embodiments, extracting the plurality of first datasets may also include, for each graph snapshot of the plurality of graph snapshots, determining the intermediate vector representation for each node based on learned coefficients and the intermediate vector representations corresponding to neighboring nodes.

At step 904, the analysis computer can extract a plurality of second datasets from the plurality of first datasets using a temporal convolution module across the plurality of graph snapshots. The plurality of second datasets can include final vector representations for each node for each snapshot of the plurality of graph snapshots. In some embodiments, extracting plurality of second datasets can further include determining the final vector representations for each node based on a convolution of intermediate vector representations corresponding to the same node at different snapshots. The different snapshots may be a sequence of snapshots immediately before the current snapshot. In some embodiments, the intermediate vector representations and the final vector representations for each node at each snapshot can be embeddings of each node in a vector space representative of characteristics of the plurality of nodes.

At step 906, the analysis computer can perform graph context prediction with at least the plurality of second datasets. For example, the analysis computer can train a machine learning model using at least the plurality of second datasets. Then the analysis computer can determine a prediction using the machine learning model, such as whether two nodes will be connected by an edge in a future graph snapshot.

At step 906, the analysis computer can perform additional processing such as, but not limited to, performing an action based on the prediction. The action can include transmitting a prediction message to another device, determining whether or not a probability value associated with the prediction (determined by the machine learning model) exceeds a predetermined probability threshold, and/or any other suitable processing of the prediction. In one example, the analysis computer can send an advisory notice that a transaction is likely to take place, or that a current transaction being attempted was not likely to take place and may therefore be fraudulent.

Embodiments of the invention can advantageously generate node embedding representations that include both local structural information and temporal evolution information. Further, embodiments can achieve these results through an efficient and scalable process. For example, the temporal convolution can have a linear complexity with respect to the number of input graph snapshots (e.g., scales with t). This provides a significant improvement over other temporal analysis methods, such as temporal self-attention (e.g., where each time-step attends to every other time-step and uses the entire graph dynamics history), which has a quadratic complexity with respect to the number of input graph snapshots (e.g., scales with t²). A method with linear complexity can process a longer sequence of graph snapshots much more efficiently (e.g., less processing power, memory, and processing time) than a method with quadratic complexity.

Embodiments of the invention can further improve efficiency through incorporating specific convolution techniques. For example, depthwise convolution can reduce the feature dimension complexity from F² (as is produced by Graph Attention Network (GAT) modeling) to F. Additionally, lightweight convolution can further reduce space complexity by sharing kernel parameters across multiple feature dimensions.

The following table (Table 1) compares the space and time complexity of Dynamic Graph Light convolution Network (DGLC), according to embodiments of the invention, with the space and time complexity of DySAT and DybAERNN, which are alternative models for dynamic graph modeling that are RNN-based and attention-based instead of convolution-based.

TABLE 1

| Model | Space Complexity per | Time Complexity per | Sequential |
|---|---|---|---|
| Type | Layer | Layer | Ops. |
| DGLC | 0(F² + NTF + ET + | 0(NTF² + ETF + | 0(1) |
| | HK) | NTFK) | |
| DySAT | 0(F² + NTF + ET + | 0(NTF² + ETF + | 0(1) |
| | NT²) | NT²F) | |
| DynAERNN | 0(NTF + ET + TF²) | 0(ETF + TF²) | 0(T) |

Space Complexity Analysis: According to some embodiments, the overall space complexity of DGLC is O(F²+NTF+ET+HK), where N is the number of nodes in a single graph snapshot, E is the corresponding number of edges, F is the feature dimension, T is the number of time steps and H is the number of convolution kernels. Space complexity comparison between and selected models are described in Table 1 and in more detail below. Note that in graphs with long dynamic evolving history, which is usually the case in many practical settings, DynAERNN is dominated by O(NTF+TF²) and DySAT is dominated by O(NT²). In practice, memory space is a limiting factor for both DynAERNN and DySAT when N and T are large, which is discussed in more detail below.

Time Complexity Analysis: Similarly, DGLC embodiments achieve an overall time complexity of O(NTF²+ETF+NTFK), where the dominant term is O(NTF²) when the kernel size K is small. DySAT's time complexity can be represented as O(NTF²+ETF+NT²F), which includes a T² term that makes it inefficient when modeling dynamic graphs with a large T. As an RNN-based model, DynAERNN has sequential operation dependence, which makes it infeasible to be processed in parallel and makes its practical training time significantly slower than both attention-based and convolution-based methods. The relative complexities are discussed in more detail below.

### IV. EXPERIMENTS

In this section, the effectiveness of DGLC is evaluated for link prediction task on six real-world datasets comparing with five state-of-the-art baselines. The following experiments aim to answer the following research questions:

| | |
|---|---|
| (RQ₁) | How does DGLC perform on link prediction tasks compared |
| | with other state-of-the-art methods? |
| (RQ₂) | Is more efficient in training when comparing with representative |
| | RNN-based and attention-based dynamic graph representation |
| | learning methods? |
| (RQ₃) | How effective and robust is each component of DGLC in |
| | modeling dynamic graph evolution? |

A. Datasets

Four different real-world dynamic graph datasets are used to conduct experiments including three communication networks and one rating network. The detailed statistics of these datasets are summarized in Table 3. Specifically, Enron and Radoslaw contain email interactions between employees where nodes represent employees and links represent interchanged emails; UCI includes message interactions between users on an online community; and ML-10M, a bipartite network, describes movies tagged by different users over time. More details about the datasets can be found a below.

B. Experimental Setup

Five state-of-the-art graph learning algorithms are selected to conduct the evaluation where two of them are static graph learning methods. These algorithms represent a diversified set of techniques that are commonly used in graph representation learning. Specifically selected are node2vec [Grover and Leskovec, 2016], GraphSAGE [Hamilton et al., 2017], DynGEM [Goyal et al., 2018], DynAERNN [Goya et al., 2020], DySAT [Sankar et al., 2020]. More details about baseline methods can be found below.

PyTorch [Paszke et al., 2019] is used to implement DGLC. For the two Enron datasets, the experimental processes employ one structural attention layer consisting 16 attention heads, where each head computes 8 features independently for a total number of 128 features. All other datasets are evaluated with two structural attention layers with 16 and 8 attention heads computing 16 features per head for a total number of 256 and 128 features. The experimental processes also conduct a grid search to determine the optimal convolution kernel size and number of kernels at each layer of the Temporal Sequence Learning module. Adam [Kingma and Ba, 2015] is used as the optimizer with weight decay as regularization to train DGLC for 200 epochs with a 256 batch size in all experiments. For each model, the experimental processes use three different random seeds to perform training and evaluation, and report the averaged results along with corresponding standard deviations. More details about the hyper-parameter settings of DGLC and other baselines are given further below.

C. Link Prediction Experiments (RQ 1)

In this section, the experimental processes describe the experiments conducted on future link prediction task and report the results together with the observed insights.

Task Description. The experimental processes select future link prediction as the task to evaluate DGLC's effectiveness compared with other baselines as it is widely adopted in dynamic graph representation learning evaluation [Sanker et al., 2020]. In particular, the experimental processes train DGLC and other baselines using the graph snapshot sequences { [symbol] , [symbol] , . . . , [symbol] }. The task is to predict link existence in [symbol] by using the latest learned node representation zᵥ^{t,L}^{ₜ} for v∈ [symbol] from the latest snapshot. For each dataset, the experimental processes evaluate the models at every time step t+1 by training individual models using graph snapshots up to t for each t=K, . . . , T−1 while K represents initial number of time steps (graph snapshots) used for evaluation which varies across different datasets for diversity purpose. The experimental processes present K used in different datasets in Table 3.

Experiment Setting. Each dataset is sliced into a discrete graph snapshot sequence where each snapshot corresponds to a fixed time interval that contains a sufficient number of links. In each set of experiments, the first t snapshots are used for model training. After obtaining the learned node representation zᵥ^{t,L}^{ₜ} ∀v∈ [symbol] , for any two nodes u and v, the experimental processes define the probability of (u,v)∈ [symbol] as:

p(u,v)=ƒ(ᵤ^{t,L}^{ₜ},ᵥ^{t,L}^{ₜ}),

where ƒ is the scoring function that takes the two node embeddings as input. In the experiment, logistic regression is used as the classifier. Specifically, the classifier is trained based on equally sampled linked and unlinked node pairs from [symbol] . For the link set E^{t+1}, the experimental processes randomly select 20% for training, 20% for validation, and 60% for testing.

Evaluation Metric. Given that link prediction can be considered as a binary classification problem, the experimental processes select the Area Under the Receiver Operating Characteristic Curve (AUC) metric to measure the performance of different models following the same practice of existing work in dynamic graph representation learning [Sankar et al., 2020; Kumar et al., 2020]. The experimental processes use both macro-AUC and micro-AUC scores for evaluation. As the experimental processes evaluate the models on each of the (t+1)^{th} graph snapshot, for each model, the experimental processes compute its final metric score by averaging the AUC scores obtained across all the graph snapshots on which it is evaluated. In particular, macro-AUC is computed by treating performances from all time steps equally, while micro-AUC considers individual contributions across time steps based on the number of evaluation links.

Results and Discussion. The experimental processes show the macro-AUC results in Table 2 and micro-AUC results in Table 4. Observations include:
DGLC achieves superior performance on most of the datasets. Specifically, it has 2.66% macro-AUC improvement on average comparing to other baselines. this indicates that DGLC can better capture both structural and temporal graph dynamics comparing to other methods. In addition, DGLC also tends to keep a smaller variance, which suggests that DGLC is more robust to random weight initialization. This may be due to regularization power provided by lightweight convolution and the fine-granularity control obtained from GLU.
Some dynamic baselines such as DynGEM and DynAERNN have inferior performance on certain datasets. The results from the hyper-parameter search and analysis, as described in more detail below, further indicate that the performance of these methods can be sensitive to hyper-parameter values, especially β. A smaller β may slow the embedding optimization process and degenerate model performance.
Static methods can have distinct performance depending on using aggregated graphs or non-aggregated graphs on different datasets. For example, models trained on aggregated graphs perform better on Enron-II, and vice-versa on Radoslaw. This also suggests that using temporal information to guide dynamic graph representation learning is imperative.

Below, in Table 2: Link prediction macro-AUC results. Two versions of evaluation for static methods: with or without information aggregation are presented. GraphSAGE results are shown with best performing aggregator: * is GCN, * is mean, † is mean-pooling, and ‡ is max-pooling.

| Model | Enron-1 | Enron-2 | UCI-1 | UCI-2 | Radoslaw | ML-10M |
|---|---|---|---|---|---|---|
| node2vec (agg) | 80.95 ± 0.6 | 80.28 ± 0.5 | 78.43 ± 0.9 | 75.98 ± 1.8 | 74.15 ± 1.0 | 90.19 ± 0.2 |
| node2vec (no agg) | 80.62 ± 0.4 | 72.30 ± 0.7 | 81.29 ± 0.1 | 75.33 ± 2.2 | 83.89 ± 0.3 | 90.66 ± 0.2 |
| GraphSAGE (agg) | 81.78* ± 0.4 | 79.70* ± 1.7 | 65.00* ± 0.7 | 64.54* ± 1.4 | 78.77* ± 1.2 | 83.14^{‡} ± 0.8 |
| GraphSAGE (no agg) | 83.38* ± 0.4 | 73.81* ± 1.5 | 66.27^{‡} ± 1.0 | 77.23^{†} ± 0.6 | 86.89* ± 0.4 | 61.90* ± 1.9 |
| DynGEM | 56.87 ± 0.6 | 60.26 ± 1.8 | 70.29 ± 0.5 | 68.29 ± 0.1 | 82.40 ± 0.4 | 64.07 ± 1.3 |
| DynAERNN | 75.78 ± 0.4 | 70.68 ± 0.6 | 58.86 ± 2.1 | 62.50 ± 1.2 | 75.30 ± 1.4 | 58.77 ± 0.2 |
| DySAT | 79.95 ± 0.8 | 83.66 ± 1.6 | 79.58 ± 0.3 | 76.33 ± 1.3 | 88.25 ± 0.8 | 88.54 ± 0.2 |
| DGLC | 85.50 ± 0.1 | 85.87 ± 0.7 | 83.83 ± 0.4 | 85.63 ± 0.3 | 88.78 ± 0.2 | 90.83 ± 0.1 |

D. Efficiency Comparison (RQ 2)

In this section, the experimental processes empirically demonstrate the efficiency advantage of DGLC, according to embodiments. Specifically, the experimental processes compare the DGLC model to DySAT and DynAERNN on the average training time per epoch at different time steps. The experimental processes choose DySAT since it not only performs better comparing to other dynamic baselines, but also scales better with its temporal self-attention advantage over RNN-based models. To fully assess the scalability of these two models on long time range dynamic graphs, the experimental processes use a Yahoo employee message dataset YHM and sample a dynamic graph sequence with one thousand time steps. Details of the experiment setup can be found further below.

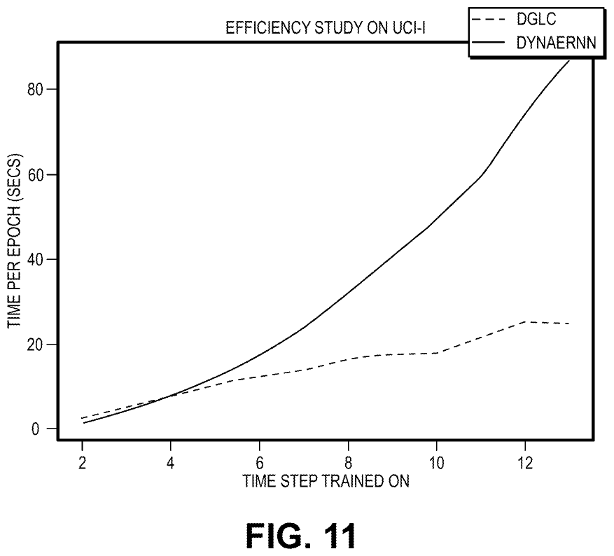

The efficiency comparison is shown in FIG. 11. The results are expected, as the training time of scales linearly with respect to number of time steps, while DySAT depicts a quadratic complexity pattern as time step increases, due to the self-attention mechanism. More importantly, as time step increases, DySAT quickly fill up most of the GPU memories, thus hardly scalable to longer sequences or multi-layer setups, due to the O(NT²) memory requirements as discussed in Section 4.4. In contrast, DGLC takes much less memory even on the largest time step, and scales linearly to number of time steps T. This empirical result validates the theoretical complexity analysis, demonstrating better efficiency of DGLC, that it is powerful in modeling dynamic graph datasets with long temporal sequences.

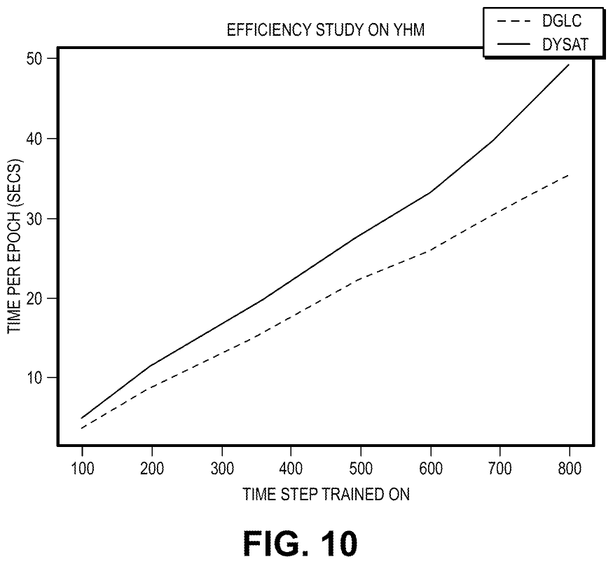

FIG. 10 and FIG. 11 compare the average training time per epoch between DGLC versus other dynamic baseline methods, DGLC, DySAT and DynAERNN. For the additional efficiency study, as shown in FIG. 5, DynAERNN scaling poorly with time that it immediately demonstrates an exponential increasing pattern, even with dataset with limited number of time steps. The result confirms the efficiency advantage of DGLC's convolutional temporal modeling over RNN-based methods.

E. Ablation Study (RQ 3)

The experimental processes conduct an ablation study to investigate how different components of DGLC may affect its temporal dynamics modeling ability. Specifically, the experimental processes select four components in the Temporal Sequence Learning module, 1) GLU; 2) feed-forward layer; 3) residual connections; and 4) weighted softmax normalization in lightweight convolution, and observe how enabling and disabling of different components can affect model performance. The experimental processes select two datasets (Enron-I and Radoslaw) to cover dynamic graphs with different lengths of time steps. The detailed experimental setup and results can be found further below. Observations are summarized below:
GLU and residual connections are vital in temporal dynamics modeling. The experimental processes observe that models with both GLU and residual connection components have consistent better performance compared with other variants on both datasets. This may suggest that a dimension-wise gating control and integrating raw temporal sequence signals can help better capture temporal evolutionary patterns in dynamic graphs.
DGLC is robust in enabling or disabling weighted softmax normalization in lightweight convolution. The original lightweight convolution [Wu et al., 2019] adds a weighted softmax normalization upon depth-wise convolution; results show that the models with or without this normalization operator has comparable performance on both datasets and shed light on further simplification of lightweight convolution.
Only applying lightweight convolution without other components demonstrates competitive performance compared with several variants such as GLU-only or FC-only models. This not only indicates the robustness of lightweight convolution, but also suggests that combining different components together can become more powerful than using any single techniques.

F. Conclusion

Embodiments of the invention provide DGLC, a novel GNN framework that effectively and efficiently learns node representations on discrete dynamic graphs. Specifically, embodiments provide a Graph Structure Learning module that includes multiple stacked layers of graph attention blocks to learn the structural information of each graph snapshot and a Temporal Sequence Learning modules that combines GLU, lightweight convolution, and residual connection to capture the evolutionary patterns of temporal information. Experimental results show that DGLC have significant performance gain over state-of-the-art baselines on real-world datasets with best training efficiency.

### V. ALGORITHM

Embodiments of the invention can be implemented with the following algorithm. Algorithm input can be: all graph snapshots G={ [symbol] , [symbol] , . . . , [symbol] }, [symbol] =(V^{t},E^{t}), V^{t}⊆V, 1≤t≤T; Lₛ the number of graph structure learning layers, Lt the number of graph temporal learning layers. Algorithm output can be: learned node embeddings eᵥ^{t} for all v∈V at each time step t that captures the evolutionary patterns of dynamic graph. The algorithm can take the following form:

| | |
|---|---|
| 1: | for t = 1 . . . T do |
| 2: | for lₛ = 1...Lₛ do |
| 3: | Graph Structure Learning Layer (GSLL) |
| 4: | hᵥ^{t,l-1}= GSLL( [symbol] ^{t}, hᵥ^{t,l-1}), hᵥ^{t,0} = xᵥ^{t} |
| 5: | end for |
| 6: | zᵥ^{t,0} = hᵥ^{t,L}^{_{G}} |
| 7: | for lₜ = 1...Lₜ do |
| 8: | Zᵥ^{l-1} = GLU (Zᵥⁱ⁻¹) |
| 9: | Graph Temporal Learning Layer (STLL) |
| 10: | zᵥ^{l,1}, . . . , Zᵥ^{t,l} = STLL(Zᵥ^{1,l-1}, . . . , zᵥ^{t,l-1}) |
| 11: | end for |
| 12: | UpdateGradient( ) |
| 13: | end for |
| 14: | ForwardPass( ) |
| 15: | return eᵥ^{t} for all ν ∈ V |

### VI. HYPER-PARAMETER SETTINGS

In this section, the hyper-parameter setting details for DGLC are discussed along with other baselines. As shown above, the loss function employed in DGLC tries to encourage nearby nodes to have similar representations across time [Hamilton et al., 2017]. The nearby nodes are retrieved from random walks, that 10 walks of length 40 with context window size 10 are sampled for each node. For each time step, 10 negative samples are used with negative sampling distribution based on node degrees with smoothing parameter of 0.75. For dataset except Enron, two structural layers are employed with 16 and 8 attention heads computing 16 features per head for a total number of 256 and 128 features, while for Enron one structural layer is used, with 16 attention heads computing 8 features per head for a total number of 128 features. Adam optimizer with weight decay parameter of 5×10⁻⁴ is used for training, along with dropout rate of 0.1 for structural learning module. The model is trained for 200 epochs with a batch size of 256. For the temporal sequence learning module, two lightweight convolution layers are employed. Validation set performance is used to tune learning rate from {10⁻⁴, 10⁻³, 5×10⁻³, 10⁻²}, negative sampling ratio from {1, 0.1, 0.01}, layer kernel size from {3, 5, 7} and number of convolution kernels from {4, 8, 16, 32} using grid search.

The hyper-parameters of all baselines are turned following their recommended suggestions. For node2vec, 10 walks of length 80 with context window size 10 are employed as recommended by the paper, tune the in-out and return hyper-parameters p, q from {0.25, 0.50, 1, 2, 4}, and training epochs from {1, 10}. For GraphSAGE, the original paper setup is followed, that employs a two layer model with sample size 25 and 10 respectively and select the best performing aggregator and training epochs from {10, 50, 100} based on validation results.

DynAERNN is tuned following the paper's recommended guidelines. The scaling and regularization hyper-parameters β are tuned from {0.1, 1, 2, 5, 8}, v₁ from {10⁻⁴, 10⁻⁶} and v₂ from {10⁻³, 10⁻⁶}. DynGEM is tuned similarly, the scaling and regularization hyper-parameters a are tuned from {10⁻⁵, 10⁻⁶}, β from {0.01, 0.05, 0.1, 1, 2, 5, 8}, v₁ from {10⁻⁴, 10⁻⁶} and v₂ from {10⁻³, 10⁻⁶}. For DySAT, the same structural learning module is kept, optimizer and loss function setup as DGLC as they provide optimal performance. 16 temporal attention heads with temporal dropout 0.5 are used as recommended, and the negative sampling ratio is tuned from {1, 0.1, 0.01} and number of temporal layers from {1, 2}. For all methods, the node embedding aimed to learn is 128.

### VII. DATASETS

This section provides additional dataset details. In order to obtain dynamic graph as graph snapshot sequences, all datasets are sliced into snapshots which contain information during fixed time intervals based on the continuous timestamps provided in the raw data, while making sure that each snapshot contains sufficient interactions/links between nodes¹. The weights of links are determined by the number of interactions between the corresponding nodes in the particular snapshot. ¹ Note that for Radoslaw dataset, in order to make sure all snapshots have sufficient interactions/links, snapshots with link number smaller than 10 are merged into the previous snapshot. This only happens 3 times out of 100.

Below in Table 3: Dataset statistics: number of nodes (IVO; number of edges (|E|); number of time steps (T); initial time step in evaluation (K).

| attribute | Enron-1 | Enron-2 | UCI-1 | UCI-2 | Radoslaw | ML-10M |
|---|---|---|---|---|---|---|
| \|ν\| | 143 | 143 | 1,809 | 1,809 | 167 | 20,537 |
| \|ε\| | 2,347 | 4,185 | 16,822 | 24,106 | 28,641 | 49,273 |
| T | 16 | 92 | 13 | 129 | 100 | 13 |
| K | 2 | 74 | 1 | 114 | 84 | 1 |

Graph snapshots are obtained at time points with fixed time intervals so that each snapshot includes a sufficient amount of links. For Enron and UCI, two time slicing strategies are applied, thus obtaining graph snapshot sequences in different granularities to better compare DGLC with other baselines in diversified scenarios. The one-hot encoding of node IDs is used as node features of these datasets in the experiments. However, DGLC is also designed to support datasets that include node attributes. The scripts for processing datasets along with all processed data will be made publicly available.

Enron. The original Enron dataset is available at https://www.cs.cmu.edu/˜./enron/, and the interactions between Enron employees are focused on her. Two versions of dynamic graphs are obtained from Enron. Enron-1, containing 16 graph snapshots, is obtained by using 2 months as time interval, and Enron-2 with 92 snapshots is obtained by using 10 days as time interval.

UCI. The original UCI dataset is available at http://networkrepository.com/opsahl_ucsocial.php. This dataset tracks message interactions between users of an online community of University of California, Irvine. Similar to Enron, two versions of dynamic graphs are obtained from UCI. UCI-1, containing 13 graph snapshots, is obtained by using 10 days as time interval, and UCI-2 with 129 snapshots is obtained by using 1 day as time interval.

Radoslaw. The original Radoslaw dataset is available at http://networkrepository.com/ia-radoslaw-email.php. This dataset contains internal email communications between employees of a manufacturing company. 100 graph snapshots are created by using time interval of 2.6 days.

ML-10M. The original ML-10M dataset is available at http://networkrepository.com/ia-movielens-user2tags-10 m.php. This dataset tracks tagging behavior of MovieLens users, that links represent tags applied on movies by users, and nodes correspond to users and movies. 13 graph snapshots are created by using time interval of 3 months.

YHM. The original YHM dataset is available at http://networkrepository.com/ia-yahoo-messages.php. This dataset tracks messages send between Yahoo employees. Since the original dataset is too large that it leads to resource exhausted issue for most methods, node sampling techniques are employed to extract 852 nodes with highest degrees, then 1,000 graph snapshots are created with time interval of 3,024 fine grained time steps.

### VIII. LINK PREDICTION EXPERIMENTS

A. Experimental Setup

For the static graph representation learning methods, to ensure a fair comparison, two strategies are used to convert the dynamic graphs to make the training and inference feasible. One strategy is only using the latest graph snapshot to train the models so that they can learn the most updated graph information. The other strategy constructs an aggregated super graph for training while link weights are set to the cumulative weights agnostic to link occurrence times. This enables the models to access the entire history of graph snapshots and obtain an overview of all graph sequence information.
node2vec [Grover and Leskovec, 2016]: A static graph embedding algorithm that learns node representations through neighborhood context prediction and biased random walk sampling.
GraphSAGE [Hamilton et al., 2017]: A spatial static graph representation learning algorithm that learns node embeddings through node sampling and neighborhood aggregation.
DynGEM [Goyal et al., 2018]: A dynamic graph learning algorithm that incrementally learns node embeddings through deep auto-encoders.
DynAERNN [Goyal et al., 2020]: A dynamic graph learning algorithm that utilizes both dense autoencoders and recurrent units to capture temporal graph dynamics.
DySAT [Sankar et al., 2020]: A dynamic graph learning algorithm that learns node representations through decoupled structural and temporal self-attention mechanism on graph snapshots.

B. Experimental Results

Table 4, shown below, presents the micro-AUC results for Link Prediction Experiments described above in the experiments section.

### IX. COMPLEXITY ANALYSIS

A. Space Complexity

In DGLC, the space complexity for Graph Attention Layer of Graph Structure Learning module is O(F²+NTF+ET), where N is the number of nodes of a single graph snapshot, E is the corresponding number of edges, and F is the feature dimension. For Lightweight Convolution layer of Temporal Sequence Learning module, the space complexity is O(NTF+HK+F²). The overall space complexity of DGLC is thus O(F²+NTF+ET+HK). On the other hand, DySAT employs the same structural space complexity as DGLC with O(F²+NTF+ET). With O(F²+NTF+NT²) from the temporal self-attention layer, DySAT yields O(F²+NTF+ET+NT²) total space complexity. For DynAERNN, due to the fully connected encoder it utilizes for capturing low dimensional representations of node neighborhoods across time, the total space complexity is O(TF²+NTF+F²).

B. Time Complexity

The time complexity for a single graph attention layer of the Graph Structure Learning module is O(NF²+EF). Note that the structural learning is independent across time thus can be parallelized. The time complexity for a single layer of the Temporal Sequence Learning module is O(TKF), where T is the number of time steps and K is kernel size. When adding GLU and a fully connected layer, time complexity becomes O(TFK+TF²). As the temporal computation is independent across nodes, it also can be parallelized to further improve the time complexity. When both two modules only has one single layer, the time complexity of DGLC for all the nodes in a graph sequence without parallelization is O(NTF²+ETF+NTFK) where the dominant term is NTF² when K is small.

As described above, two state-of-the art models are selected: DynAERNN and DySAT as baselines in this experiment as can be considered as the representatives of two main categories of dynamic graph representation learning methods: i.e., RNN-based and attention-based models. For DySAT, the per layer time complexity for temporal self-attention is O(T²F), since it requires each time step attends to every other time step of the sequence. When employing the same graph attention layer as the structural learning module, the total time complexity of DySAT with one structural attention layer and one temporal attention layer without parallelization for all the nodes in a graph sequence is O(NTF²+ETF+NT²F). Note that DySAT includes a T² term its total time complexity, which makes it inefficient when modeling dynamic graphs with a large T.

Each temporal layer of DynAERNN includes a fully-connected layer as input encoder and a LSTM cell as recurrent unit, which has a time complexity O(ETF+TF²) when processing T graph snapshots. However, as a recurrent layer has sequential dependence, which can't be processed in parallel, its practical training time is significantly slower than attention-based methods. Applying a convolution-based solution, DGLC has no sequential dependency on historical processing and the time complexity linear in T, which makes it powerful for modeling dynamic graphs with long temporal sequences. The detailed comparison can be found in Table 1.

### X. EFFICIENCY COMPARISON

A. Experimental Setup

In this section, experimental details are provided for efficiency study. To ensure fairness, while keeping all common settings (i.e., batch size) the same, the experimental processes employ the same structural learning module setup and use the same number of temporal layers for DGLC and DySAT. Both of the models are implemented via PyTorch, and the experimental processes compute the training time used per epoch averaged across 10 epochs for every 100 time steps from 100 to 800 on YHM dataset, running on Nvidia Tesla V100 with 64 CPU cores.

The experimental processes also include an additional efficiency study by comparing DGLC with DynAERNN, to empirically demonstrate the efficiency advantage of DGLC over RNN-based dynamic graph learning methods. Similar to the previous study, the experimental processes compare DGLC to DynAERNN on the average training time per epoch at different time steps, where both utilize a complete dynamic graph snapshot sequence. The experimental processes use the original DynAERNN implementation based on TensorFlow, and averaged epoch training time is computed for every time step from 2 to 13 on UCH dataset, by running the two models on Nvidia Tesla P100 with 48 CPU cores.

B. Experimental Results

FIG. 4 and FIG. 5 compare the average training time per epoch between DGLC versus other dynamic baseline methods, i.e., DySAT and DynAERNN. For both figures, the x-axis represents the time steps and the y-axis represents the average time spent per epoch when training the corresponding graph snapshot at the corresponding time steps. The experimental processes also use the blue color to indicate DGLC and use orange to indicate baseline models. For the additional efficiency study, as shown in FIG. 5, DynAERNN scaling poorly with time that it immediately demonstrates an exponential increasing pattern, even with dataset with limited number of time steps. The result confirms the efficiency advantage of DGLC's convolutional temporal modeling over RNN-based methods.

Below, in Table 4: Link prediction experiment micro-AUC results. Two versions of evaluation for static methods: with or without information aggregation are presented. GraphSAGE results are shown with best performing aggregator: * is GCN, * is mean, t is mean-pooling, and is max-pooling. The best results for each dataset are highlighted in bold.

| Model | Enron- 1 | Enron- 2 | UCI- 1 | UCI- 2 | Radoslaw | ML-10M |
|---|---|---|---|---|---|---|
| node2vec (agg) | 83.01 ± 0.5 | 82.21 ± 0.6 | 78.29 ± 0.8 | 77.35 ± 2.0 | 74.09 ± 0.9 | 90.53 ± 0.2 |
| node2vec (no agg) | 81.82 ± 0.5 | 73.27 ± 0.3 | 77.71 ± 0.1 | 75.70 ± 2.1 | 84.16 ± 0.4 | 90.89 ± 0.2 |
| GraphSAGE (agg) | 83.57* ± 0.1 | 79.62* ± 1.5 | 65.07* ± 0.2 | 65.01* ± 1.4 | 79.44* ± 1.2 | 84.12^{‡} ± 0.9 |
| GraphSAGE (no agg) | 84.75* ± 0.7 | 74.93* ± 1.2 | 65.13^{‡} ± 0.7 | 77.61^{†} ± 0.8 | 86.61* ± 0.4 | 61.71* ± 1.9 |
| DynGEM | 56.99 ± 0.2 | 61.46 ± 0.8 | 71.33 ± 0.6 | 68.90 ± 0.1 | 82.23 ± 0.4 | 65.03 ± 1.5 |
| DynAERNN | 78.55 ± 0.3 | 70.51 ± 0.4 | 53.20 ± 0.9 | 62.60 ± 1.6 | 74.56 ± 1.4 | 59.60 ± 0.3 |
| Dy SAT | 83.10 ± 0.1 | 85.13 ± 1.2 | 73.83 ± 0.5 | 76.84 ± 0.7 | 88.07 ± 0.7 | 89.12 ± 0.2 |
| DGLC | 87.13 ± 0.1 | 87.15 ± 0.3 | 81.11 ± 0.1 | 85.24 ± 0.8 | 88.54 ± 0.2 | 91.32 ± 0.1 |

### XI. ABLATION STUDY

The four components selected to analyze in the Ablation Study as described in Sec. 5.5 are: 1) weighted softmax normalization in the lightweight convolution operator; 2) GLU; 3) feed-forward layer with ReLU activation; and 4) residual connections. The experimental processes conduct an exhaustive search on all possible combination of different components to construct 2⁴=16 model variants and compare their performance in Table 5 (macro-AUC) and Table 6 (micro-AUC) where a symbol indicates the presence of the corresponding component and a symbol indicates its absence. The experimental processes select two datasets (Enron-I and Radoslaw) as they can be considered as dynamic graph representatives with different time step lengths. Similar to the Link Prediction Experiments (Sec. 5.3), the experimental processes use three different random seeds to train DGLC for 200 epochs with a 512 batch size. The experiments were conducted using Nvidia Tesla P100 with 48 CPU cores.

In the below, Table 5: Ablation study on DGLC temporal module component combinations, evaluated with macro-AUC with std. deviation on Enron-I and Radoslaw dataset. Note that the std. deviations are averaged across time steps for each setting.

| Temporal Module Components | | | | | |
|---|---|---|---|---|---|
| | Gated | Feed- | | | |
| Softmax | Linear | forward | Residual | DGLC Perf. | |
| Norm. | Unit | Layer | Connection | Enron-I | Radoslaw |
| x | x | x | x | 76.96 ± 0.8 | 84.81 ± 0.2 |
| ✓ | x | x | x | 80.07 ± 0.5 | 86.12 ± 0.9 |
| x | ✓ | x | x | 70.06 ± 0.7 | 80.64 ± 0.7 |
| x | x | ✓ | x | 75.37 ± 1.5 | 82.30 ± 0.6 |
| x | x | x | ✓ | 85.31 ± 0.6 | 87.02 ± 0.8 |
| ✓ | ✓ | x | x | 75.04 ± 0.9 | 80.82 ± 0.5 |
| ✓ | x | ✓ | x | 78.51 ± 1.5 | 86.02 ± 0.6 |
| ✓ | x | x | ✓ | 83.93 ± 0.8 | 77.60 ± 2.0 |
| x | ✓ | ✓ | x | 64.65 ± 2.3 | 80.66 ± 0.4 |
| x | ✓ | x | ✓ | 86.06 ± 0.9 | 89.10 ± 0.5 |
| x | x | ✓ | ✓ | 85.51 ± 0.4 | 88.11 ± 0.2 |
| ✓ | ✓ | ✓ | x | 69.35 ± 1.3 | 82.75 ± 0.5 |
| ✓ | ✓ | x | ✓ | 85.81 ± 0.9 | 88.82 ± 0.6 |
| ✓ | x | ✓ | ✓ | 85.29 ± 0.9 | 86.85 ± 0.2 |
| x | ✓ | ✓ | ✓ | 86.04 ± 0.4 | 88.65 ± 0.4 |
| ✓ | ✓ | ✓ | ✓ | 86.03 ± 0.3 | 88.34 ± 0.3 |

In the below, Table 6: Ablation study on DGLC temporal module component combinations, evaluated with micro-AUC with std. deviation on Enron-I and Radoslaw dataset. Note that the std. deviations are averaged across time steps for each setting.

| Temporal Module Components | | | | | |
|---|---|---|---|---|---|
| | Gated | Feed- | | | |
| Softmax | Linear | forward | Residual | DGLC Perf. | |
| Norm | Unit | Layer | Connection | Enron-I | Radoslaw |
| x | x | x | x | 78.94 ± 0.2 | 84.47 ± 0.2 |
| ✓ | x | x | x | 83.35 ± 0.3 | 86.04 ± 0.9 |
| x | ✓ | x | x | 70.11 ± 1.2 | 80.65 ± 1.0 |
| x | x | ✓ | x | 77.88 ± 0.5 | 82.06 ± 0.5 |
| x | x | x | ✓ | 86.78 ± 0.3 | 86.54 ± 0.8 |
| ✓ | ✓ | x | x | 77.61 ± 1.5 | 80.39 ± 0.6 |
| ✓ | x | ✓ | x | 82.93 ± 0.5 | 85.82 ± 0.5 |
| ✓ | x | x | ✓ | 85.34 ± 0.4 | 77.35 ± 1.9 |
| x | ✓ | ✓ | x | 64.13 ± 1.6 | 80.60 ± 0.1 |
| x | ✓ | x | ✓ | 87.66 ± 0.4 | 88.63 ± 0.4 |
| x | x | ✓ | ✓ | 87.24 ± 0.6 | 87.73 ± 0.2 |
| ✓ | ✓ | ✓ | x | 71.27 ± 1.4 | 82.51 ± 0.5 |
| ✓ | ✓ | x | ✓ | 87.35 ± 0.3 | 88.43 ± 0.5 |
| ✓ | x | ✓ | ✓ | 87.05 ± 0.5 | 86.43 ± 0.1 |
| x | ✓ | ✓ | ✓ | 87.56 ± 0.2 | 88.21 ± 0.4 |
| ✓ | ✓ | ✓ | ✓ | 87.22 ± 0.3 | 87.95 ± 0.1 |

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

### XII. REFERENCES

[Bruna et al., 2014] Joan Bruna, Wojciech Zaremba, Arthur Szlam, and Yann LeCun. Spectral networks and locally connected networks on graphs. In ICLR, 2014.
[Chen et al., 2018] Jinyin Chen, Xuanheng Xu, Yangyang Wu, and Haibin Zheng. GC-LSTM: graph convolution embedded LSTM for dynamic link prediction. CoRR, abs/1812.04206, 2018.
[Dauphin et al., 2017] Yann N. Dauphin, Angela Fan, Michael Auli, and David Grangier. Language modeling with gated convolutional networks. In ICML, volume 70, pages 933-941, 2017.
[Defferrard et al., 2016] Michael Defferrard, Xavier Bresson, and Pierre Vandergheynst. Convolutional neural networks on graphs with fast localized spectral filtering. In NeurIPS, pages 3837-3845, 2016.
[Goyal et al., 2018] Palash Goyal, Nitin Kamra, Xinran He, and Yan Liu. Dyngem: Deep embedding method for dynamic graphs. CoRR, abs/1805.11273, 2018.
[Goyal et al., 2020] Palash Goyal, Sujit Rokka Chhetri, and Arquimedes Canedo. dyngraph2vec: Capturing network dynamics using dynamic graph representation learning. Knowl. Based Syst., 187, 2020.
[Grover and Leskovec, 2016] Aditya Grover and Jure Leskovec. node2vec: Scalable feature learning for networks. In KDD, pages 855-864, 2016.
[Hamilton et al., 2017] William L. Hamilton, Zhitao Ying, and Jure Leskovec. Inductive representation learning on large graphs. In NeurIPS, pages 1024-1034, 2017.
[He et al., 2016] Kaiming He, Xiangyu Zhang, Shaoqing Ren, and Jian Sun. Deep residual learning for image recognition. In CVPR, pages 770-778, 2016.
[Islam et al., 2020] Md. Amirul Islam, Sen Jia, and Neil D. B. Bruce. How much position information do convolutional neural networks encode? In ICLR, 2020.
[Kingma and Ba, 2015] Diederik P. Kingma and Jimmy Ba. Adam: A method for stochastic optimization. In ICLR, 2015.
[Kipf and Welling, 2017] Thomas N. Kipf and Max Welling. Semi-supervised classification with graph convolutional networks. In ICLR, 2017.
[Kumar et al., 2019] Srijan Kumar, Xikun Zhang, and Jure Leskovec. Predicting dynamic embedding trajectory in temporal interaction networks. In KDD, pages 1269-1278, 2019.
[Levie et al., 2019] Ron Levie, Federico Monti, Xavier Bresson, and Michael M. Bronstein. Cayleynets: Graph convolutional neural networks with complex rational spectral filters. IEEE Trans. Signal Process., 67(1):97-109, 2019.
[Manessi et al., 2020] Franco Manessi, Alessandro Rozza, and Mario Manzo. Dynamic graph convolutional networks. Pattern Recognition, 97, 2020.
[Nguyen et al., 2018] Giang Hoang Nguyen, John Boaz Lee, Ryan A. Rossi, Nesreen K. Ahmed, Eunyee Koh, and Sungchul Kim. Continuous-time dynamic network embeddings. In WWW, pages 969-976, 2018.
[Pareja et al., 2020] Aldo Pareja, Giacomo Domeniconi, Jie Chen, Tengfei Ma, Toyotaro Suzumura, Hiroki Kanezashi, Tim Kaler, Tao B. Schardl, and Charles E. Leiserson. Evolvegcn: Evolving graph convolutional networks for dynamic graphs. In AAAI, pages 5363-5370, 2020.
[Paszke et al., 2019] Adam Paszke, Sam Gross, Francisco Massa, Adam Lerer, James Bradbury, Gregory Chanan, Trevor Killeen, Zeming Lin, Natalia Gimelshein, Luca Antiga, Alban Desmaison, Andreas Kopf, Edward Yang, Zach DeVito, Martin Raison, Alykhan Tejani, Sasank Chilamkurthy, Benoit Steiner, Lu Fang, Junjie Bai, and Soumith Chintala. Pytorch: An imperative style, high-performance deep learning library. CoRR, abs/1912.01703, 2019.
[Perozzi et al., 2014] Bryan Perozzi, Rami Al-Rfou, and Steven Skiena. Deepwalk: online learning of social representations. In KDD, pages 701-710, 2014.
[Sankar et al., 2020] Aravind Sankar, Yanhong Wu, Liang Gou, Wei Zhang, and Hao Yang. Dysat: Deep neural representation learning on dynamic graphs via self-attention networks. In WSDM, pages 519-527, 2020.
[Seo et al., 2018] Youngjoo Seo, Michael Defferrard, Pierre Vandergheynst, and Xavier Bresson. Structured sequence modeling with graph convolutional recurrent networks. In ICONIP, volume 11301, pages 362-373, 2018.
[Trivedi et al., 2019] Rakshit Trivedi, Mehrdad Farajtabar, Prasenjeet Biswal, and Hongyuan Zha. Dyrep: Learning representations over dynamic graphs. In ICLR, 2019.
[Velickovic et al., 2018] Petar Velickovic, Guillem Cucurull, Arantxa Casanova, Adriana Romero, Pietro Liò, and Yoshua Bengio. Graph attention networks. In ICLR, 2018.
[Wu et al., 2019] Felix Wu, Angela Fan, Alexei Baevski, Yann N. Dauphin, and Michael Auli. Pay less attention with lightweight and dynamic convolutions. In ICLR, 2019.
[Xu et al., 2019] Keyulu Xu, Weihua Hu, Jure Leskovec, and Stefanie Jegelka. How powerful are graph neural networks? In ICLR, 2019.
[Xu et al., 2020] Da Xu, Chuanwei Ruan, Evren Körpeoglu, Sushant Kumar, and Kannan Achan. Inductive representation learning on temporal graphs. In ICLR, 2020.
[Ying et al., 2018] Rex Ying, Ruining He, Kaifeng Chen, Pong Eksombatchai, William L. Hamilton, and Jure Leskovec. Graph convolutional neural networks for webscale recommender systems. In KDD, pages 974-983, 2018.
[Zitnik et al., 2018] Marinka Zitnik, Monica Agrawal, and Jure Leskovec. Modeling polypharmacy side effects with graph convolutional networks. Bioinform., 34(13):i457-i466, 2018.

What is claimed is:

1. A method comprising:
extracting, by an analysis computer, a plurality of first datasets from a plurality of graph snapshots using a graph structural learning module;
extracting, by the analysis computer, a plurality of second datasets from the plurality of first datasets using a temporal convolution module across the plurality of first datasets;
performing, by the analysis computer, graph context prediction based on the plurality of second datasets; and
performing, by the analysis computer, an action based on the graph context prediction.

2. The method of claim 1, wherein each graph snapshot of the plurality of graph snapshots comprises a plurality of nodes that represent entities and a plurality of edges represent that interactions between the entities, each node of the plurality of nodes connected to neighboring nodes of the plurality of nodes by one or more edges of the plurality of edges.

3. The method of claim 2, wherein the plurality of first datasets includes intermediate vector representations for each node for each snapshot of the plurality of graph snapshots, the intermediate vector representations each including a first plurality of feature values corresponding to a plurality of feature dimensions.

4. The method of claim 3, wherein the plurality of second datasets include final vector representations for each node for each graph snapshot of the plurality of graph snapshots, the final vector representations each including a second plurality of feature values corresponding to the plurality of feature dimensions, wherein the intermediate vector representations and the final vector representations are embeddings of each node in a vector space representative of characteristics of the plurality of nodes.

5. The method of claim 4, wherein extracting the plurality of second datasets further comprises:
determining a plurality of convolution kernels, each of the plurality of convolution kernels corresponding to at least one feature dimension of the plurality of feature dimensions; and
performing temporal convolution on each of the intermediate vector representations using the plurality of convolution kernels to produce the final vector representations.

6. The method of claim 5, wherein each graph snapshot of the plurality of graph snapshots includes graph data associated with a timestamp.

7. The method of claim 6, wherein each of the plurality of nodes are temporal convoluted separately, and each feature dimension of each node are temporal convoluted separately.

8. The method of claim 7, wherein performing temporal convolution includes, for each feature dimension of each node, applying a corresponding convolution kernel from the plurality of convolution kernels to a subset of first feature values of the feature dimension, the subset of first feature values corresponding to a subset of consecutive timestamps.

9. The method of claim 8, wherein applying the corresponding convolution kernel provides a result, and the result is used as a second feature value of the feature dimension at a last timestamp from the subset of consecutive timestamps.

10. The method of claim 8, wherein each convolution kernel has a predefined length, and wherein a number of first feature values in the subset of first feature values is equal to the predefined length of the convolution kernel.

11. The method of claim 1, wherein the temporal convolution module utilizes depthwise convolution or lightweight convolution.

12. The method of claim 3, wherein extracting the plurality of first datasets further comprises:
for each graph snapshot of the plurality of graph snapshots, determining an intermediate vector representation for each node based on learned coefficients and intermediate vector representations corresponding to neighboring nodes.

13. An analysis computer comprising:
a processor; and
a computer readable medium coupled to the processor, the computer readable medium comprising code, executable by the processor, for implementing a method comprising:
extracting a plurality of first datasets from a plurality of graph snapshots using a graph structural learning module;
extracting a plurality of second datasets from the plurality of first datasets using a temporal convolution module across the plurality of first datasets;
performing graph context prediction based on the plurality of second datasets; and
performing an action based on the graph context prediction.

14. The analysis computer of claim 13, further comprising:
the graph structural learning module coupled to the processor; and
the temporal convolution module coupled to the processor.

15. The analysis computer of claim 13, wherein the method further comprises:
receiving a prediction request from a requesting client;
determining a prediction based on at least performing graph context prediction based on the plurality of second datasets; and
transmitting, to the requesting client, a prediction response comprising the prediction.

16. The analysis computer of claim 13, further comprising:
training a machine learning model using at least the plurality of second datasets.

17. The analysis computer of claim 16, wherein the graph context prediction is performed using the plurality of second datasets and the machine learning model.

18. The analysis computer of claim 16, wherein the machine learning model is an SVM or a neural network.

19. The analysis computer of claim 13, wherein each graph snapshot of the plurality of graph snapshots comprises a plurality of nodes that represent entities, wherein the plurality of first datasets includes intermediate vector representations for each node for each snapshot of the plurality of graph snapshots, the intermediate vector representations each including a first plurality of values corresponding to a plurality of feature dimensions, wherein the plurality of second datasets include final vector representations for each node for each graph snapshot of the plurality of graph snapshots, the final vector representations each including a second plurality of values corresponding to the plurality of feature dimensions.

20. The analysis computer of claim 19, wherein extracting the plurality of second datasets further comprises:
determining a plurality of convolution kernels based on the intermediate vector representations, each of the plurality of convolution kernels corresponding to at least one feature dimension of the plurality of feature dimensions;
performing temporal convolution on each of the intermediate vector representations using the plurality of convolution kernels; and
determining the final vector representations based on the temporal convolution.
